(19) United States
(12) Patent Application Publication
(10) Pub. No.: US 2025/0099985 A1
(43) Pub. Date: Mar. 27, 2025

(54) LIQUID DISPENSING DEVICE AND LIQUID DISCHARGE SYSTEM

(71) Applicant: FUJIAN XIHE SANITARY WARE TECHNOLOGY CO., LTD., Nan'an (CN)

(72) Inventors: Xiaofa Lin, Nan'an (CN); Xiaoshan Lin, Nan'an (CN); Mingnan Wang, Nan'an (CN); Pansheng Liang, Nan'an (CN); Zhiwei Chen, Nan'an (CN); Xiaoqing Deng, Nan'an (CN); Qiqiao Liu, Nan'an (CN)

(73) Assignee: FUJIAN XIHE SANITARY WARE TECHNOLOGY CO., LTD., Nan'an (CN)

(21) Appl. No.: 18/784,612

(22) Filed: Jul. 25, 2024

(30) Foreign Application Priority Data
Sep. 22, 2023 (CN) 202311234714.4
Apr. 9, 2024 (CN) 202420724181.1

(51) Int. Cl. B05B 1/30; E03C 1/02; E03C 1/04

(52) U.S. Cl. CPC B05B 1/3026; E03C 1/0408; E03C 2001/026

(57) ABSTRACT

A liquid dispensing device and a liquid discharge system are disclosed. The liquid dispensing device includes a liquid dispensing mechanism and an operation mechanism. The liquid dispensing mechanism includes a main body assembly and a movable assembly, the main body assembly is provided with a liquid intake channel and multiple liquid discharge channels, and the movable assembly is movably installed to the main body assembly. The operation mechanism is capable of driving the movable assembly to rotate relative to the main body assembly, so as to discommunicate at least one of the multiple liquid discharge channels from the liquid intake channel, or to communicate the multiple liquid discharge channels with the liquid intake channel. The operation mechanism is detachably connected with the liquid dispensing mechanism.

### CROSS-REFERENCE TO RELATED APPLICATIONS

The present application claims priority to Chinese Patent Application No. 202311234714.4, filed on Sep. 22, 2023 and Chinese Patent Application No. 202420724181.1, filed on Apr. 9, 2024, the contents of which are incorporated by reference herein in their entireties.

### TECHNICAL FIELD

The present disclosure relates to, but is not limited to, kitchen and bathroom technologies, and particularly relates to a liquid dispensing device and a liquid discharge system.

### BACKGROUND

In some cases, a liquid dispensing device enables at least one of different liquid discharge elements of a liquid discharge system to discharge the liquid by changing a flow direction of liquid, so as to meet the usage requirements of the user.

However, versatility among various parts of the liquid dispensing device is poor. If the operation structure of the liquid dispensing device needs to be updated and upgraded, then it is necessary to remake a whole mold, which will increase the production cost greatly. In addition, the poor versatility among the various parts of the liquid dispensing device makes the user need to re-purchase a liquid dispensing device when the user wishes to upgrade and change an operation mode or an operation structure is damaged and needs to be replaced. A cost of upgrading and changing and replacing the liquid dispensing device is higher.

### SUMMARY

The present disclosure provides a liquid dispensing device including a liquid dispensing mechanism and an operation mechanism. The liquid dispensing device includes a main body assembly and a movable assembly, the main body assembly is provided with a liquid intake channel and multiple liquid discharge channels, and the movable assembly is movably installed to the main body assembly. The operation mechanism is detachably connected with the liquid dispensing mechanism, and the operation mechanism is capable of driving the movable assembly to rotate relative to the main body assembly, so as to discommunicate at least one of the multiple liquid discharge channels from the liquid intake channel, or to communicate the multiple liquid discharge channels with the liquid intake channel.

The present disclosure also provides a liquid discharge system, including: the liquid dispensing device as described above; and multiple liquid discharge elements. The multiple liquid discharge elements are communicated in one-to-one correspondence with the multiple liquid discharge channels.

An implementation of embodiments of the present disclosure will have the following beneficial effects.

The liquid dispensing device of the above-mentioned solution is applied to and installed in the liquid discharge system, and in addition to realizing the effect of switching liquid discharge modes of different liquid discharge elements of the liquid discharge system, the liquid dispensing device itself may further improve a versatility of the liquid dispensing device. Specifically, the liquid dispensing device includes a liquid dispensing mechanism and an operation mechanism. The liquid dispensing mechanism includes a main body assembly provided with a liquid intake channel and multiple liquid discharge channels, and a movable assembly movably installed to the main body assembly. The operation mechanism is capable of driving the movable assembly to rotate relative to the main body assembly, so as to discommunicate at least one of the multiple liquid discharge channels from the liquid intake channel, or to communicate the multiple liquid discharge channels with the liquid intake channel. In this way, by rotating the movable assembly relative to the main body assembly, the communication state between the liquid intake channel and the multiple liquid discharge channels may be changed, and different liquid discharge channels may be switched to discharge liquid or all the liquid discharge channels may be closed simultaneously according to specific usage requirements. The operation mechanism is detachably connected to the liquid dispensing mechanism, so that when the operation mechanism or the liquid dispensing mechanism is updated and upgraded, it is not necessary to make a mold for the whole liquid dispensing device, thereby reducing the production cost caused by updating and upgrading. When the user wishes to upgrade and change an operation mode or a liquid dispensing mode and an operation structure or a liquid dispensing structure is damaged and needs to be replaced, the liquid dispensing device does not need to be purchased as a whole, thereby reducing a cost of upgrading, changing and replacing the liquid dispensing device.

Other aspects will become apparent after reading and understanding the drawings and detailed description.

### BRIEF DESCRIPTION OF THE DRAWINGS

The drawings are used to provide an understanding of the technical solutions of the present disclosure, constitute a part of the specification, and together with the embodiments of the present disclosure, are used to explain the technical solutions of the present disclosure, but do not form limitations on the technical solutions of the present disclosure.

FIG. 1 is a schematic diagram of a liquid discharge system according to an embodiment of the present disclosure.

FIG. 2 is a schematic diagram of a liquid dispensing device according to an embodiment of the present disclosure.

FIG. 3 is a partial exploded schematic diagram of a structure of the liquid dispensing device shown in FIG. 2.

FIG. 4 is a partial exploded schematic diagram of a structure of the liquid dispensing device shown in FIG. 2 from another perspective.

FIG. 5 is an exploded schematic diagram of a structure of the liquid dispensing device shown in FIG. 2.

FIG. 6 is an enlarged schematic diagram of a structure of Part A in FIG. 5.

FIG. 7 is a schematic diagram of a liquid dispensing device according to another embodiment of the present disclosure.

FIG. 8 is a partial exploded schematic diagram of a structure of the liquid dispensing device shown in FIG. 7.

FIG. 9 is an enlarged schematic diagram of a structure of Part B in FIG. 8.

FIG. 10 is an enlarged schematic diagram of a structure of Part C in FIG. 8.

FIG. 11 is a partial exploded schematic diagram of a structure of the liquid dispensing device shown in FIG. 7 from another perspective.

FIG. 12 is an enlarged schematic diagram of a structure of Part D in FIG. 11.

FIG. 13 is an exploded schematic diagram of a structure of the liquid dispensing device shown in FIG. 7.

FIGS. 14A and 14B are schematic diagrams of two other exemplary embodiments of the liquid dispensing device shown in FIG. 7.

FIG. 15 is a schematic diagram of a liquid dispensing device according to yet another embodiment of the present disclosure.

FIG. 16 is a partial exploded schematic diagram of a structure of the liquid dispensing device shown in FIG. 15.

FIG. 17 is an enlarged schematic diagram of a structure of Part E in FIG. 16.

FIG. 18 is a partial exploded schematic diagram of a structure of the liquid dispensing device shown in FIG. 15 from another perspective.

FIG. 19 is an exploded schematic diagram of a structure of the liquid dispensing device shown in FIG. 15.

FIGS. 20A and 20B are schematic diagrams of two other exemplary embodiments of the liquid dispensing device shown in FIG. 15.

FIG. 21 is a schematic diagram of a liquid dispensing device according to yet another embodiment of the present disclosure.

FIG. 22 is a partial exploded schematic diagram of a structure of the liquid dispensing device shown in FIG. 21.

FIG. 23 is a partial exploded schematic diagram of a structure of the liquid dispensing device shown in FIG. 21 from another perspective.

FIG. 24 is an exploded schematic diagram of a structure of the liquid dispensing device shown in FIG. 21.

FIG. 25 is a schematic diagram of another exemplary embodiment of the liquid dispensing device shown in FIG. 21.

FIG. 26 is a schematic assembly diagram of a liquid dispensing element and a movable assembly in a liquid dispensing device according to an embodiment of the present disclosure.

FIG. 27 is an exploded schematic diagram of a structure of a liquid dispensing element and a movable assembly in a liquid dispensing device according to an embodiment of the present disclosure.

FIG. 28 is a schematic diagram of positions of a driving element and a transmission element in a liquid dispensing device according to an embodiment of the present disclosure, in which a first liquid discharge channel and a second liquid discharge channel simultaneously discharge liquid.

FIG. 29 is a schematic diagram of positions of a transmission element and a gear element in a liquid dispensing device according to an embodiment of the present disclosure, in which a first liquid discharge channel and a second liquid discharge channel simultaneously discharge liquid.

FIG. 30 is a sectional view taken along F-F in FIG. 29.

FIG. 31 is an enlarged schematic diagram of a structure of Part G in FIG. 30.

FIG. 32 is an enlarged schematic diagram of a structure of Part H in FIG. 30.

FIG. 33 is a schematic diagram of positions of a sealing element and a first liquid discharge channel and a second liquid discharge channel in a liquid dispensing device according to an embodiment of the present disclosure, in which the first liquid discharge channel and the second liquid discharge channel simultaneously discharge liquid.

FIG. 34 is a schematic diagram of positions of a driving element and a transmission element in a liquid dispensing device according to an embodiment of the present disclosure, in which a first liquid discharge channel discharges liquid.

FIG. 35 is a schematic diagram of positions of a transmission element and a gear element in a liquid dispensing device according to an embodiment of the present disclosure, in which a first liquid discharge channel discharges liquid.

FIG. 36 is a schematic diagram of positions of a sealing element and a first liquid discharge channel and a second liquid discharge channel in a liquid dispensing device according to an embodiment of the present disclosure, in which the first liquid discharge channel discharges liquid.

FIG. 37 is a schematic diagram of positions of a driving element and a transmission element in a liquid dispensing device according to an embodiment of the present disclosure, in which a second liquid discharge channel discharges liquid.

FIG. 38 is a schematic diagram of positions of a transmission element and a gear element in a liquid dispensing device according to an embodiment of the present disclosure, in which a second liquid discharge channel discharges liquid.

FIG. 39 is a schematic diagram of positions of a sealing element and a first liquid discharge channel and a second liquid discharge channel in a liquid dispensing device according to an embodiment of the present disclosure, in which the second liquid discharge channel discharges liquid.

FIG. 40 is a schematic diagram of a liquid dispensing device according to an embodiment of the present disclosure.

FIG. 41 is a partial exploded schematic diagram of a structure of the liquid dispensing device shown in FIG. 40.

FIG. 42 is an enlarged schematic diagram of a structure of Part I in FIG. 41.

FIG. 43 is an enlarged schematic diagram of a structure of Part J in FIG. 41.

FIG. 44 is a partial exploded schematic diagram of a structure of the liquid dispensing device shown in FIG. 40 from another perspective.

FIG. 45 is an enlarged schematic diagram of a structure of Part K in FIG. 44.

FIG. 46 is an exploded schematic diagram of a structure of the liquid dispensing device shown in FIG. 40.

FIG. 47 is an enlarged schematic diagram of a structure of Part L in FIG. 46.

FIG. 48 is a schematic assembly diagram of a liquid dispensing element and a movable assembly in a liquid dispensing device according to an embodiment of the present disclosure.

FIG. 49 is an exploded schematic diagram of a structure of a liquid dispensing element and a movable assembly in a liquid dispensing device according to an embodiment of the present disclosure.

FIG. 50 is a schematic diagram of a structure of a driving element in a liquid dispensing device according to an embodiment of the present disclosure.

FIG. 51 is a schematic diagram of a structure of an outer housing in a liquid dispensing device according to an embodiment of the present disclosure.

FIG. 52 is a schematic assembly diagram of a driving element and an outer housing in a liquid dispensing device according to an embodiment of the present disclosure.

FIG. 53 is a schematic diagram of a structure of an inner core in a liquid dispensing device according to an embodiment of the present disclosure.

FIG. 54 is a schematic diagram of a structure of a liquid dispensing element in a liquid dispensing device according to an embodiment of the present disclosure.

FIG. 55 is a schematic diagram of positions of a driving element and a transmission element in a liquid dispensing device according to an embodiment of the present disclosure, in which a first liquid discharge channel and a second liquid discharge channel simultaneously discharge liquid.

FIG. 56 is a schematic diagram of positions of a transmission element and a gear element in a liquid dispensing device according to an embodiment of the present disclosure, in which a first liquid discharge channel and a second liquid discharge channel simultaneously discharge liquid.

FIG. 57 is a sectional view taken along M-M in FIG. 55.

FIG. 58 is an enlarged schematic diagram of a structure of Part N in FIG. 57.

FIG. 59 is an enlarged schematic diagram of a structure of Part O in FIG. 57.

FIG. 60 is a schematic diagram of positions of a sealing element and a first liquid discharge channel and a second liquid discharge channel in a liquid dispensing device according to an embodiment of the present disclosure, in which the first liquid discharge channel and the second liquid discharge channel simultaneously discharge liquid.

FIG. 61 is a schematic diagram of positions of a driving element and a transmission element in a liquid dispensing device according to an embodiment of the present disclosure, in which a first liquid discharge channel discharges liquid.

FIG. 62 is a schematic diagram of positions of a transmission element and a gear element in a liquid dispensing device according to an embodiment of the present disclosure, in which a first liquid discharge channel discharges liquid.

FIG. 63 is a schematic diagram of positions of a sealing element and a first liquid discharge channel and a second liquid discharge channel in a liquid dispensing device according to an embodiment of the present disclosure, in which the first liquid discharge channel discharges liquid.

FIG. 64 is a schematic diagram of positions of a driving element and a transmission element in a liquid dispensing device according to an embodiment of the present disclosure, in which a second liquid discharge channel discharges liquid.

FIG. 65 is a schematic diagram of positions of a transmission element and a gear element in a liquid dispensing device according to an embodiment of the present disclosure, in which a second liquid discharge channel discharges liquid.

FIG. 66 is a schematic diagram of positions of a sealing element and a first liquid discharge channel and a second liquid discharge channel in a liquid dispensing device according to an embodiment of the present disclosure, in which the second liquid discharge channel discharges liquid.

Reference signs are described as follows.

10 liquid dispensing device; 11 liquid dispensing mechanism; 111 main body assembly; 1111 housing; 11111 first connection part; 11112 second connection part; 11113 third connection part; 11114 third limiting part; 1112 liquid dispensing element; 11121 first positioning element; 111211 first positioning part; 11122 sprung arm; 11123 second positioning element; 111231 second positioning part; 11124 second limiting part; 112 movable assembly; 1121 rotation element; 11210 second installation space; 112101 hole wall; 11211 second plug part; 1122 sealing element; 11221 flexible part; 112211 arc-shaped protrusion; 11222 elastic part; 12 operation mechanism; 121 rotary element; 1211 protrusion; 1212 first plug part; 12121 elastic arm; 1213 driving protrusion; 122 connection element; 1221 first sliding part; 1222 abutment part; 1223 first limiting part; 1224 rotary shaft; 1225 outer housing; 12251 limiting protrusion; 1226 inner core; 12261 limiting strip; 12262 second guiding part; 12263 fourth limiting part; 123 driving element; 1231 clamp opening part; 1232 first driving part; 12321 arc-shaped surface; 124 transmission element; 1241 second sliding part; 1242 rack; 1243 second driving part; 12431 groove wall; 1244 movement part; 1245 connection plate; 125 gear element; 1251 positioning plate; 126 second positioning assembly; 1261 installation component; 12610 first installation space; 1262 abutment component; 1263 elastic component; 1214 first positioning assembly; 12141 installation element; 121410 installation hole; 12142 abutment element; 12143 elastic element; 13 positioning component; 131 abutment structure; 132 elastic structure; 14 pin shaft; 20 shower head; 30 top sprayer; 40 supporting liquid intake assembly; 50 liquid intake assembly; 60 hose; 70 fixation structure; 100 liquid intake channel; 200 first liquid discharge channel; 201 first liquid discharge hole; 300 second liquid discharge channel; 301 second liquid discharge hole; 400 liquid intake cavity; 500 clamping groove; 600 accommodation groove; 700 first plugging space; 800 sliding groove; 900 first guiding part; 1000 penetrating slot; 1100 positioning groove; 1200 limiting groove; 1300 avoidance space; 1400 liquid discharge channel.

The realization of the objects, functional features and advantages of the present disclosure are further explained with reference to the accompanying drawings in connection with the embodiments.

### DETAILED DESCRIPTION

The present disclosure describes multiple embodiments, but this description is exemplary and not limiting, and it will be obvious to those of ordinary skills in the art that more embodiments and implementations may be included within the scope of the embodiments described by the present disclosure. Although many possible combinations of features are shown in the drawings and discussed in the detailed description, many other combinations of the disclosed features are also possible. Unless specifically limited, any feature or element of any embodiment may be used in combination with, or may substitute for, any other feature or element of any other embodiment.

The present disclosure includes and contemplates combinations with features and elements known to those of ordinary skills in the art. The disclosed embodiments, features, and elements of the present disclosure may also be combined with any conventional features or elements to form a unique inventive solution as defined by the claims. Any feature or element of any embodiment may also be combined with feature(s) or element(s) from other inventive solution to form another unique inventive solution as defined by the claims. Accordingly, it should be understood that any of the features shown and/or discussed in the present disclosure may be implemented alone or in any suitable combination. Thus, the embodiments are not subjected to limitations other than those made in accordance with the appended claims and their equivalent substitutions. In addition, various modifications and changes may be made within the protection scope of the appended claims.

Furthermore, when describing representative embodiments, the specification may have presented a method and/or process as a particular sequence of steps. However, to the extent that the method or process does not depend on the specific order of steps described by the present disclosure, the method or process should not be limited to the specific order of steps. As will be understood by those of ordinary skill in the art, other order of steps is also possible. Accordingly, a particular order of steps set forth in the specification should not be construed as limitations on the claims. Furthermore, the claims for the method and/or process should not be limited to the steps which are performed in the written order. Those skilled in the art can readily understand that these orders can be changed and the changed orders still remain within the spirit and scope of the embodiments of the present disclosure.

In some cases, a liquid dispensing device enables at least one of different liquid discharge elements of a liquid discharge system to discharge the liquid by changing a flow direction of liquid, so as to meet the usage requirements of the user.

However, versatility among various parts of the liquid dispensing device is poor. If the operation structure of the liquid dispensing device needs to be updated and upgraded, then it is necessary to remake a whole mold, which will increase the production cost greatly. In addition, the poor versatility among the various parts of the liquid dispensing device makes the user need to re-purchase a liquid dispensing device when the user wishes to upgrade and change an operation mode or an operation structure is damaged and needs to be replaced. A cost of upgrading and changing and replacing the liquid dispensing device is higher.

An embodiment of the present disclosure provides a liquid dispensing device and a liquid discharge system. The liquid discharge system may be installed in various occasions and environments, such as companies, schools, families, factories and the like, to realize cleaning effect and improve and enhance life quality and health of people. The liquid discharge system may be, but is not limited to, one or more combinations of a water outlet faucet, a shower head, a top sprayer and a spray gun. In order to facilitate the description of the technical solution of the present disclosure, illustration is made below by taking a case in which a liquid discharge system is a shower kit consisting of a shower head and a top sprayer as an example.

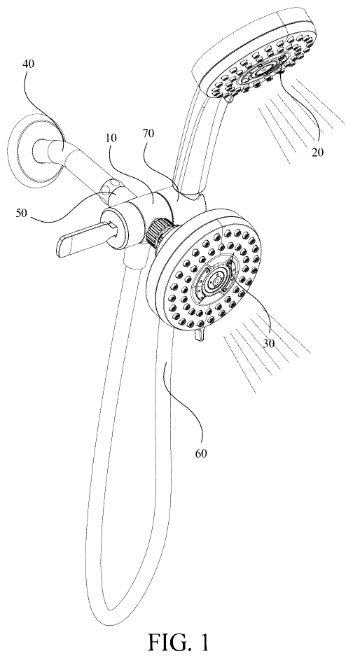

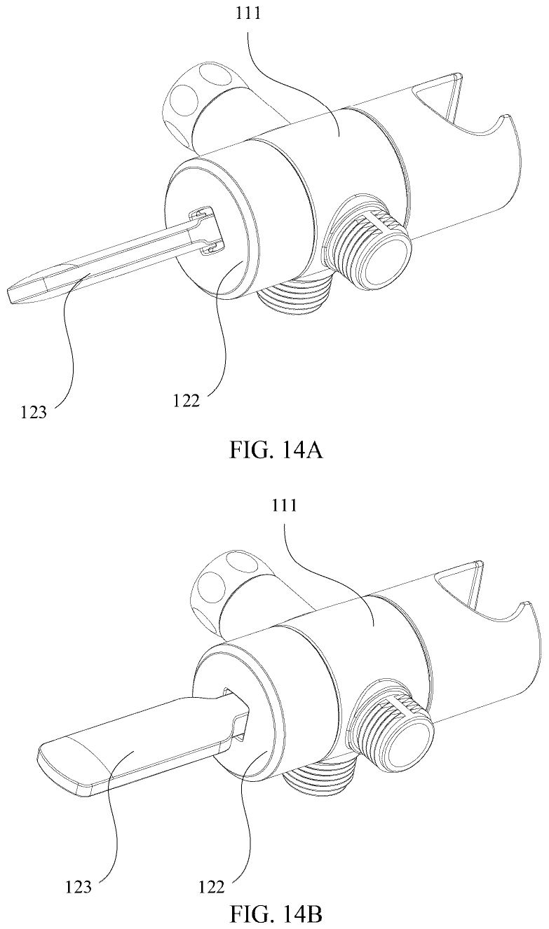

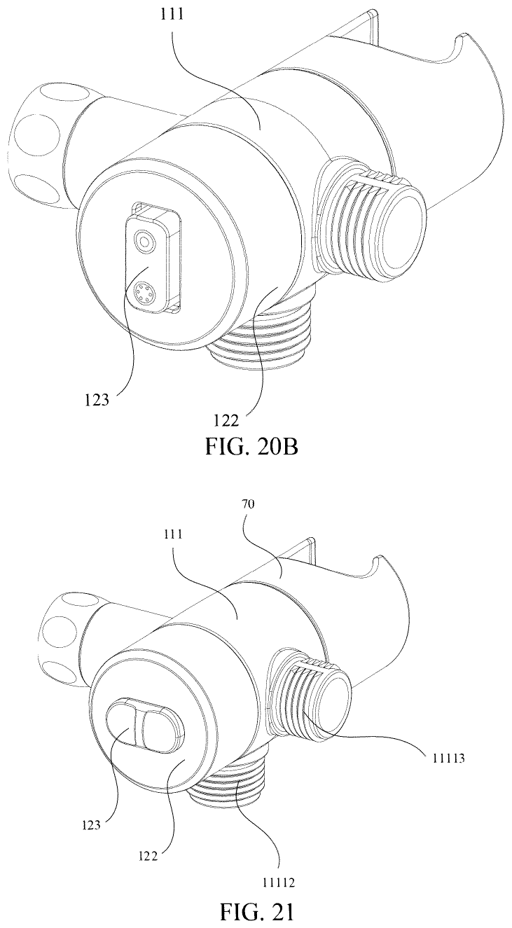

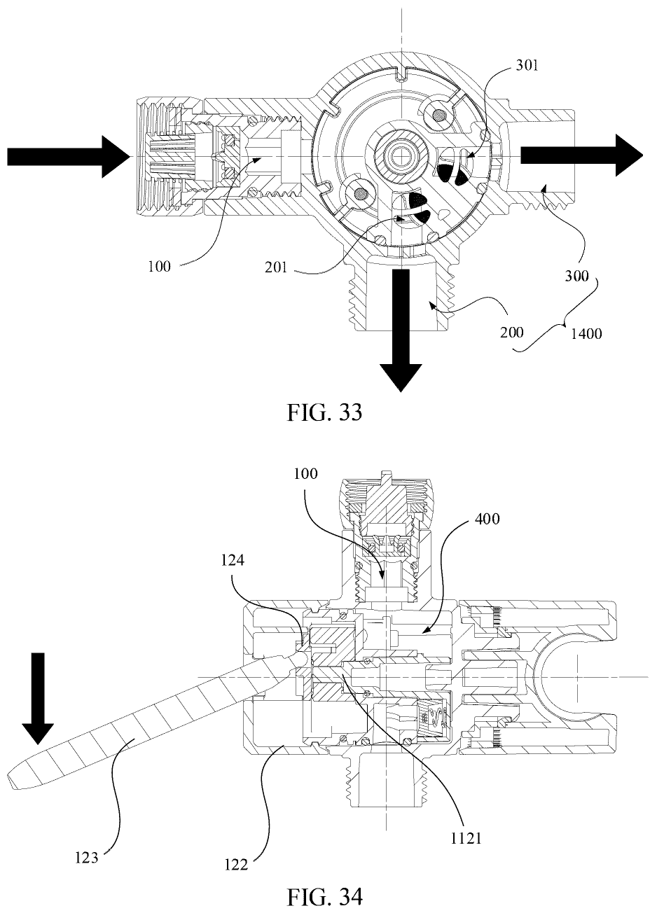

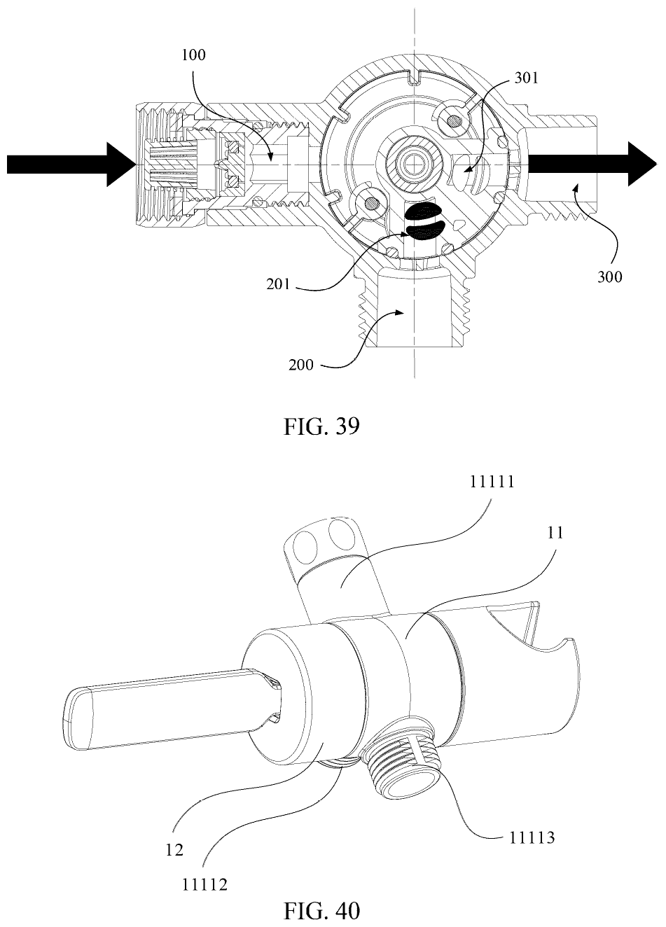

References are made to FIGS. 1 to 7, 14A, 14B, 15, 20A, 20B, 21, 25, 28, 33, 34, 36, 37 and 39 together to describe the liquid discharge system provided by an embodiment of the present disclosure. The liquid discharge system includes a liquid dispensing device 10 and multiple liquid discharge elements. The liquid dispensing device 10 includes a liquid dispensing mechanism 11 and an operation mechanism 12. The liquid dispensing mechanism 11 includes a main body assembly 111 and a movable assembly 112. The main body assembly 111 is provided with a liquid intake channel 100 and multiple liquid discharge channels 1400, and the movable assembly 112 is movably installed to the main body assembly 111. The operation mechanism 12 is detachably connected to the liquid dispensing mechanism 11, and the operation mechanism 12 is capable of driving the movable assembly 112 to rotate relative to the main body assembly 111, so as to discommunicate at least one of the multiple liquid discharge channels 1400 from the liquid intake channel 100, or to communicate the multiple liquid discharge channels 1400 with the liquid intake channel 100. The multiple liquid discharge elements are communicated in one-to-one correspondence with the multiple liquid discharge channels 1400.

In an embodiment of the present disclosure, the multiple liquid discharge elements may include a shower head 20 and a top sprayer 30. A quantity of liquid discharge channels 1400 may be two, including a first liquid discharge channel 200 in communication with the shower head 20 and a second liquid discharge channel 300 in communication with the top sprayer 30. A rotation trajectory of the movable assembly 112 relative to the main body assembly 111 includes at least a first position and a second position and a third position located on two sides of the first position. At the first position, the first liquid discharge channel 200 and the second liquid discharge channel 300 simultaneously discharge liquid. At the second position, the first liquid discharge channel 200 discharges liquid. At the third position, the second liquid discharge channel 300 discharges liquid.

The liquid discharge system further includes a supporting liquid intake assembly 40. A liquid intake assembly 50 communicating between the supporting liquid intake assembly 40 and the liquid intake channel 100 is provided on the liquid dispensing mechanism 11. A first connection part 11111 connected to the liquid intake assembly 50 is provided on the liquid dispensing mechanism 11. The first connection part 11111 may be connected to the liquid intake assembly 50 by, but not limited to, threaded connection, plug connection, clamping connection, or welding. The liquid dispensing device 10 is provided on a wall or other mounting base by the supporting liquid intake assembly 40. The supporting liquid intake assembly 40 is configured to be capable of providing liquid to the liquid intake channel 100. The supporting liquid intake assembly 40 may have, but is not limited to have, a manually controlled or an electrically controlled valve configuration, and the liquid intake channel 100 is communicated with or discommunicated from a liquid source by controlling an opening or closing of the supporting liquid intake assembly 40. The liquid includes, but is not limited to, clear water or pure water from a municipal water network.

A second connection part 11112 is provided on the liquid dispensing mechanism 11. The second connection part 11112 may be connected to a hose 60 by means of, but not limited to, threaded connection, plug connection, clamping connection, or welding, and is in communication with the shower head 20 through the hose 60, so that the shower head 20 is in communication with the first liquid discharge channel 200.

A third connection part 11113 is provided on the liquid dispensing mechanism 11. The third connection part 11113 may be connected to the top sprayer 30 by, but not limited to, threaded connection, plug connection, clamping connection, or welding, so as to realize communication between the top sprayer 30 and the second liquid discharge channel 300.

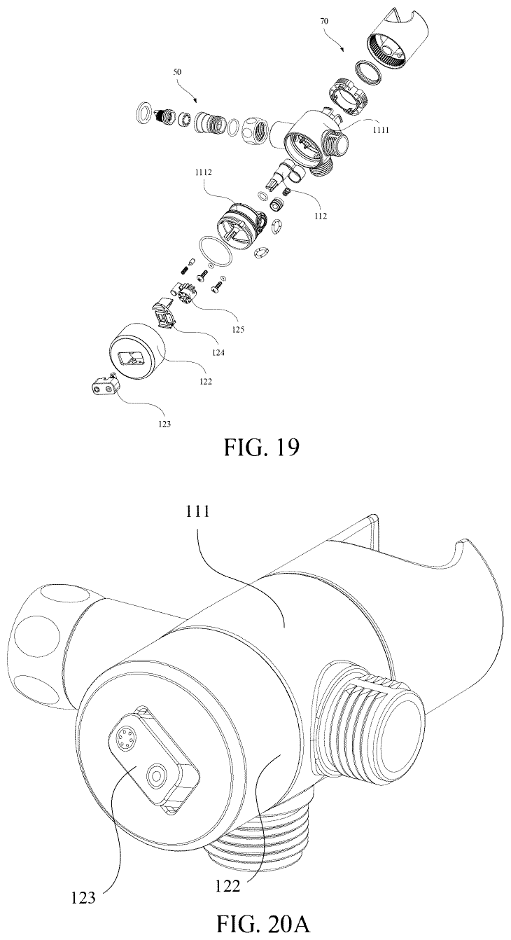

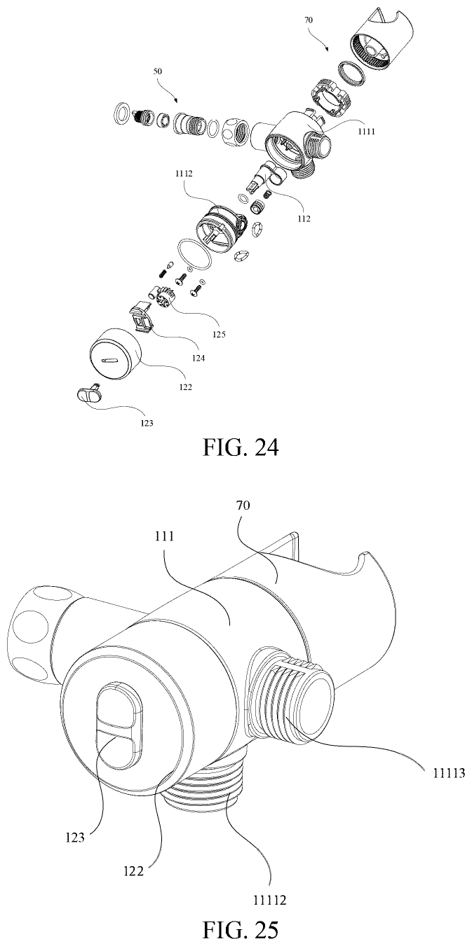

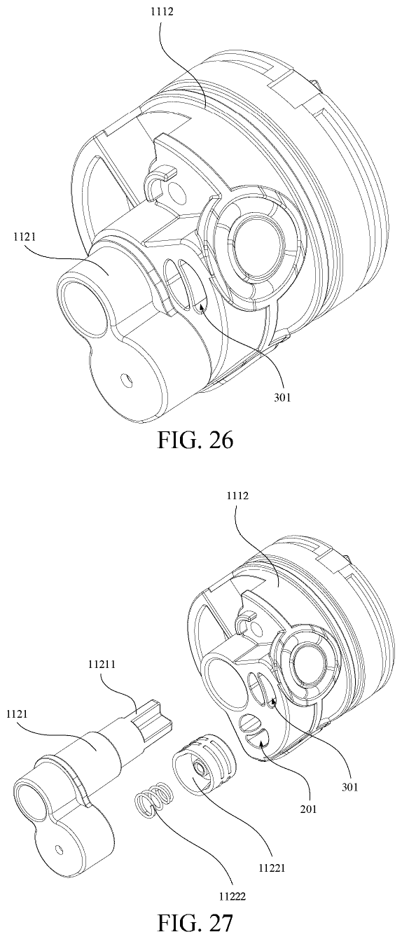

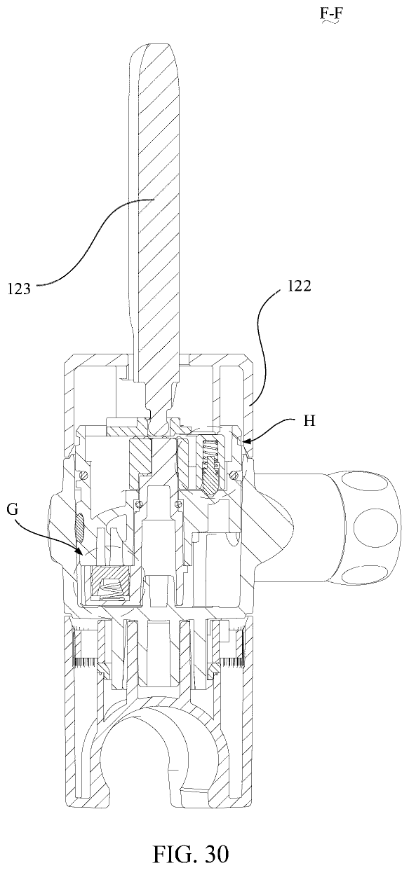

In an exemplary embodiment, referring to FIGS. 5, 6, 13, 19, 24, 26 to 28, 30, 33, 34, 36, 37 and 39 together, the main body assembly 111 includes a housing 1111 and a liquid dispensing element 1112. The liquid dispensing element 1112 is detachably installed in the housing 1111 or integrally provided with the housing 1111. The first connection part 11111, the second connection part 11112, and the third connection part 11113 are provided on the housing 1111. The housing 1111 and the liquid dispensing element 1112 enclose and form a liquid intake cavity 400 communicated with the liquid intake channel 100. The first liquid discharge channel 200 may form a first liquid discharge hole 201 on the liquid dispensing element 1112. The second liquid discharge channel 300 may form a second liquid discharge hole 301 on the liquid dispensing element 1112. The operation mechanism 12 is capable of driving the movable assembly 112 to rotate relative to the main body assembly 111, so as to discommunicate at least one of the first liquid discharge hole 201 and the second liquid discharge hole 301 from the liquid intake cavity 400, or to communicate both the first liquid discharge hole 201 and the second liquid discharge hole 301 with the liquid intake cavity 400. Thereby, at least one of the first liquid discharge channel 200 and the second liquid discharge channel 300 is disscommunicated from the liquid intake channel 100, or both the first liquid discharge channel 200 and the second liquid discharge channel 300 are communicated with the liquid intake channel 100.

The operation mechanism 12 is capable of driving the movable assembly 112 to rotate relative to the main body assembly 111, so as to discommunicate at least one of the first liquid discharge channel 200 and the second liquid discharge channel 300 from the liquid intake channel 100, or to communicate both the first liquid discharge channel 200 and the second liquid discharge channel 300 with the liquid intake channel 100. That is, it can be switched between a mode of the shower head 20 discharging liquid, a mode of the top sprayer 30 discharging liquid, a mode of both the shower head 20 and the top sprayer 30 not discharging liquid, and a mode of both the shower head 20 and the top sprayer 30 discharging liquid. The liquid dispensing mechanism 11 is further provided with a fixation structure 70, which may be detachably connected with the shower head 20.

In summary, an implementation of embodiments of the present disclosure will have the following beneficial effects: the liquid dispensing device 10 of the above-mentioned solution is applied to and installed in the liquid discharge system, and in addition to realizing the effect of switching liquid discharge of different liquid discharge elements of the liquid discharge system, the liquid dispensing device 10 itself may further improve the versatility of the liquid dispensing device 10. Specifically, the liquid dispensing device 10 includes a liquid dispensing mechanism 11 and an operation mechanism 12. The liquid dispensing mechanism 11 includes a main body assembly 111 provided with a liquid intake channel 100 and multiple liquid discharge channels 1400, and a movable assembly 112 movably installed to the main body assembly 111. The operation mechanism 12 is capable of driving the movable assembly 112 to rotate relative to the main body assembly 111, so as to discommunicate at least one of the multiple liquid discharge channels 1400 from the liquid intake channel 100, or to communicate the multiple liquid discharge channels 1400 with the liquid intake channel 100. In this way, by rotating the movable assembly 112 relative to the main body assembly 111, the communication state between the liquid intake channel 100 and the multiple liquid discharge channels 1400 may be changed, and different liquid discharge channels 1400 may be switched to discharge liquid or all the liquid discharge channels 1400 may be closed simultaneously according to specific usage requirements. The operation mechanism 12 is detachably connected to the liquid dispensing mechanism 11, so that when the operation mechanism 12 or the liquid dispensing mechanism 11 is updated and upgraded, it is not necessary to make a mold for the whole liquid dispensing device 10, thereby reducing the production cost caused by updating and upgrading. When the user wishes to upgrade and change an operation mode or a liquid dispensing mode and an operation structure or a liquid dispensing structure is damaged and needs to be replaced, the liquid dispensing device 10 does not need to be purchased as a whole, thereby reducing a cost of upgrading, changing and replacing the liquid dispensing device 10.

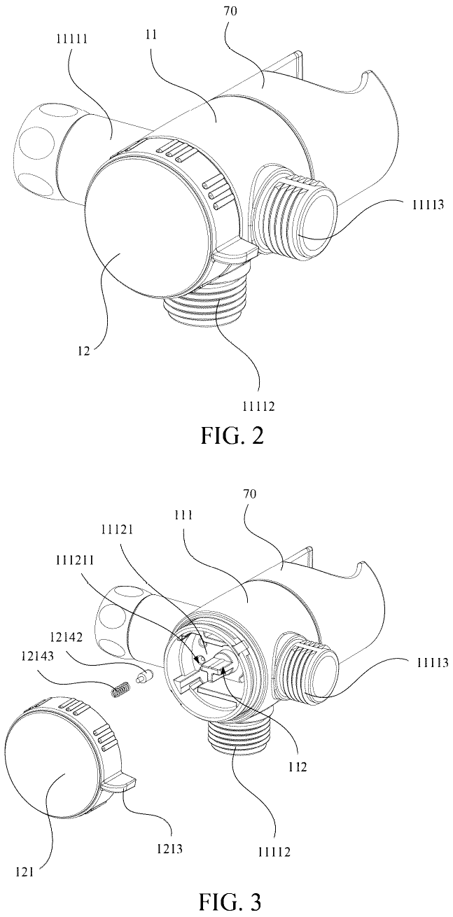

In an exemplary embodiment, referring to FIGS. 2 to 6 together, the operation mechanism 12 includes a rotary element 121. The rotary element 121 is detachably connected to the movable assembly 112. In this way, when the operation mechanism 12 or the liquid dispensing mechanism 11 is updated and upgraded, and when the user wishes to upgrade and change the operation mode or the liquid dispensing mode, and the operation structure or the liquid dispensing structure is damaged and needs to be replaced, the rotary element 121 may be separated from the movable assembly 112, so that the separation between the operation mechanism 12 and the liquid dispensing mechanism 11 is realized, and one of the operation mechanism 12 and the liquid dispensing mechanism 11 is replaced while the other of the operation mechanism 12 and the liquid dispensing mechanism 11 is retained, so that a portion of the liquid dispensing device 10 is universal, which is cost effective. The rotary element 121 is capable of driving the movable assembly 112 to rotate relative to the main body assembly 111, so as to discommunicate at least one of the multiple liquid discharge channels 1400 from the liquid intake channel 100, or to communicate the multiple liquid discharge channels 1400 with the liquid intake channel 100.

In an exemplary embodiment, referring to FIGS. 2 to 4 and 6 together, one of the rotary element 121 and the main body assembly 111 is provided with a protrusion 1211, and the other of the rotary element 121 and the main body assembly 111 is provided with a clamping groove 500. The rotary element 121 may be clamped with the main body assembly 111 by a cooperation between the protrusion 1211 and the clamping groove 500, and may rotate relative to the main body assembly 111 so as to drive the movable assembly 112 to rotate relative to the main body assembly 111. In this way, a fast assembly of the rotary element 121 and the main body assembly 111 may be realized by the cooperation between the protrusion 1211 and the clamping groove 500. At the same time, by the cooperation between the protrusion 1211 and the clamping groove 500, the rotary element 121 may also rotate relative to the main body assembly 111, and the rotation stability of the rotary element 121 is improved, thereby improving the stability of driving the movable assembly 112. In addition, the rotary element 121 may increase a connection area between the rotary element 121 and the main body assembly 111 by the cooperation between the protrusion 1211 and the clamping groove 500 to improve the connection stability.

At least one of the rotary element 121 and the main body assembly 111 may also be elastically deformed to move the protrusion 1211 out of the clamping groove 500. This enables a detachable connection between the rotary element 121 and the main body assembly 111.

In an embodiment of the present disclosure, the protrusion 1211 is provided on the rotary element 121, and the clamping groove 500 is provided on the liquid dispensing element 1112, and the clamping groove 500 may extend in a circumferential direction of the liquid dispensing element 1112 to facilitate the rotation of the rotary element 121. An extension distance of the clamping groove 500 may be designed to define a rotation range of the rotary element 121. In addition, in some embodiments, the clamping groove 500 may also be provided on the housing 1111 and cooperated with the protrusion 1211 provided on the rotary element 121. It may be understood that in other embodiments, the clamping groove 500 may also be provided on the rotary element 121, and correspondingly, the protrusion 1211 is provided on the liquid dispensing element 1112 or the housing 1111.

In an exemplary embodiment, referring to FIGS. 3, 4, and 6 together, the operation mechanism 12 further includes a first positioning assembly 1214. The first positioning assembly 1214 is provided on one of the main body assembly 111 and the rotary element 121, and a first positioning element 11121 is provided on the other of the main body assembly 111 and the rotary element 121. Optionally, the first positioning assembly 1214 is provided on one of the main body assembly 111 and the movable assembly 112, and a first positioning element 11121 is provided on the other of the main body assembly 111 and the movable assembly 112. Multiple first positioning parts 111211 are provided on the first positioning element 11121, and the multiple first positioning parts 111211 are configured to cooperate with the first positioning assembly 1214 for positioning under different communication or discommunication states between the liquid intake channel 100 and the multiple liquid discharge channels 1400 respectively.

In an embodiment of the present disclosure, three first positioning parts 111211 corresponding to the first position, the second position, and the third position are provided on the first positioning element 11121 to cooperate with the first positioning assembly 1214 when the movable assembly 112 rotates to the first position, the second position, and the third position, thus realizing a position feedback to prompt the rotation position of the movable assembly 112. The first positioning assembly 1214 is provided at the rotary element 121 and the main body assembly 111 is provided with the first positioning element 11121.

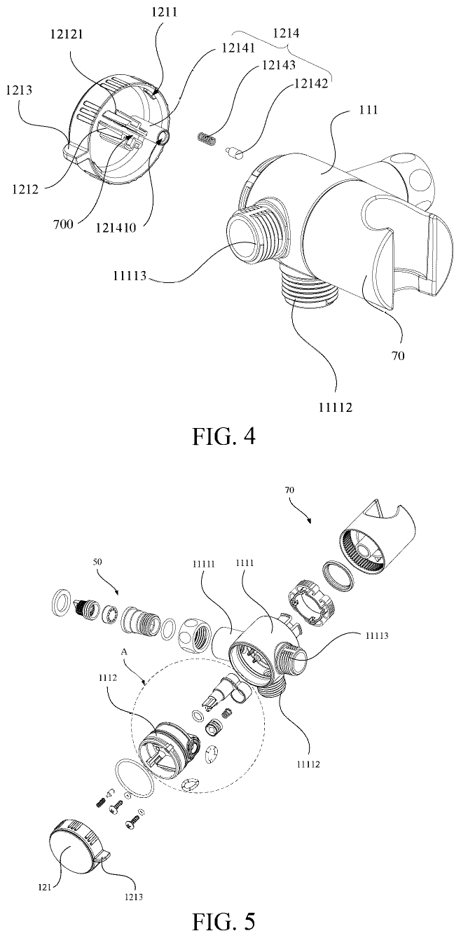

In an exemplary embodiment, as shown in FIG. 4, the first positioning assembly 1214 includes an installation element 12141, an abutment element 12142, and an elastic element 12143. The installation element 12141 is provided with an installation hole 121410, the abutment element 12142 is partially located in the installation hole 121410 and capable of a sliding connection with the first positioning element 11121, and the elastic element 12143 is installed in the installation hole 121410 and capable of abutting the abutment element 12142 against the first positioning element 11121, so that a cooperation between the abutment element 12142 and the first positioning element 11121 may be tighter by an arrangement of the elastic element 12143, and a gap between the abutment element 12142 and the first positioning element 11121 may be avoided, which results in abnormal noise generated when the abutment element 12142 slides relative to the first positioning element 11121.

In an embodiment of the present disclosure, the first positioning part 111211 has a groove structure, and the elastic element 12143 may further enable the abutment element 12142 to be relatively stable in the groove structure, so as to improve the accuracy of the position feedback. The elastic element 12143 may be, but is not limited to, a metal spring element and a plastic spring.

The elastic element 12143 is installed in the installation hole 121410, so that an extension and retraction of the elastic element 12143 has a certain directionality. The abutment element 12142 has a columnar structure and a spherical crown. The abutment element 12142 is partially located in the installation hole 121410, and may improve a movement accuracy under a restriction of the installation element 12141. An arrangement of the spherical crown enables the abutment element 12142 to slide more smoothly relative to the first positioning element 11121, and avoids an occurrence of a jamming phenomenon.

In an embodiment of the present disclosure, the installation element 12141 has a columnar structure and is provided on the rotary element 121, and the liquid dispensing element 1112 is provided with the first positioning element 11121.

In an exemplary embodiment, referring to FIGS. 3, 4, and 6 together, a first plug part 1212 is provided on the rotary element 121, and the movable assembly 112 is inserted into and in anti-rotation cooperation with the first plug part 1212. In this way, a rapid assembly and detachable connection between the rotary element 121 and the movable assembly 112 may be realized by an engagement between the first plug part 1212 and the movable assembly 112 in an insertion manner. A second plug part 11211 that is inserted into and mated with the first plug part 1212 is provided on the movable assembly 112. One of the first plug part 1212 and the second plug part 11211 has a first plugging space 700, and the other of the first plug part 1212 and the second plug part 11211 may be inserted into the first plugging space 700. The first plugging space 700 has a non-circular structure, and the first plug part 1212 or the second plug part 11211 inserted into the first plugging space 700 matches with the first plugging space 700 to form an anti-rotation cooperation. In an embodiment of the present disclosure, the first plug part 1212 has the first plugging space 700, and the second plug part 11211 is inserted into the first plugging space 700. The first plugging space 700 is a T-shaped groove, and the second plug part 11211 has a T-shaped structure with which the T-shaped groove cooperates.

In an exemplary embodiment, as shown in FIG. 4, the first plug part 1212 includes multiple elastic arms 12121, the multiple elastic arms 12121 are provided on the rotary element 121 and enclose the first plugging space 700, and the second plug part 11211 of the movable assembly 112 is inserted into the first plugging space 700. In this way, the second plug part 11211 of the movable assembly 112 may be clamped and held by the multiple elastic arms 12121, and a stability of rotary transmission is improved. At the same time, an elastic deformation of the elastic arms 12121 facilitates the rapid assembly and separation between the first plug part 1212 and the second plug part 11211 of the movable assembly 112. Further, in an embodiment of the present disclosure, a quantity of elastic arms 12121 is two. A reinforcement structure is further provided between the elastic arms 12121 and the rotary element 121 to further increase a strength of the elastic arms 12121 and ensure the stability of the rotary transmission between the rotary element 121 and the movable assembly 112.

In an exemplary embodiment, referring to FIGS. 2 to 5 together, a driving protrusion 1213 is provided on the rotary element 121 and configured to be capable of driving the rotary element 121 to rotate relative to the main body assembly 111. In this way, the rotary element 121 may be driven conveniently through an arrangement of the driving protrusion 1213. The driving protrusion 1213 may rotate with the rotary element 121, and while the communication state between the liquid intake channel 100 and the multiple liquid discharge channels 1400 is changed by rotation of the rotary element 121, a rotation position of the driving protrusion 1213 may provide a more obvious indication of the communication state, thus improving the user experience.

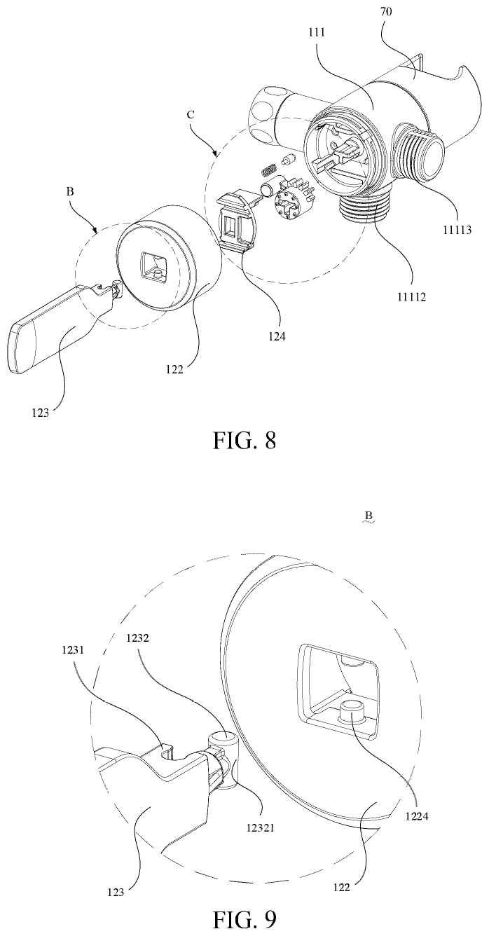

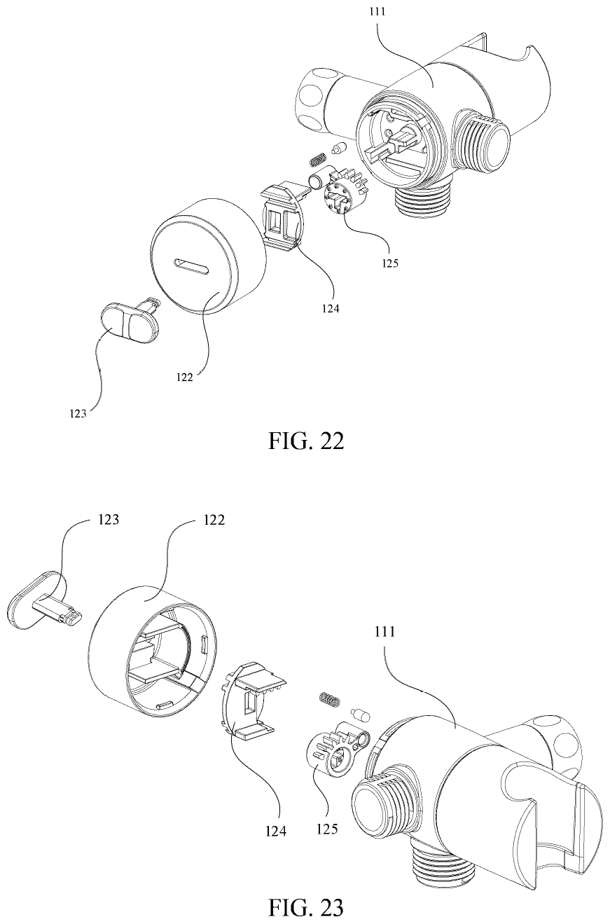

In an exemplary embodiment, referring to FIGS. 7, 8, 11, 13 to 16, 18 to 25 together, the operation mechanism 12 includes a connection element 122, a driving element 123, and a transmission element 124. The connection element 122 is detachably connected to the main body assembly 111, and the driving element 123 and the transmission element 124 are both movably connected to the connection element 122, so that the driving element 123 and the transmission element 124 may be detachably connected to the main body assembly 111 together with the connection element 122. When the operation mechanism 12 or the liquid dispensing mechanism 11 is updated and upgraded, and when the user wishes to upgrade and change the operation mode or the liquid dispensing mode, and the operation structure or the liquid dispensing structure is damaged and needs to be replaced, the driving element 123, the transmission element 124 and the connection element 122 as a whole may be separated from the main body assembly 111. Separation between the operation mechanism 12 and the liquid dispensing mechanism 11 is realized. One of the operation mechanism 12 and the liquid dispensing mechanism 11 is replaced, and the other of the operation mechanism 12 and the liquid dispensing mechanism 11 is retained, so that a portion of the liquid dispensing device 10 is universal, which is cost effective. The driving element 123 is movable relative to the connection element 122 to drive the movable assembly 112 to rotate relative to the main body assembly 111 by the transmission element 124, so as to discommunicate at least one of the multiple liquid discharge channels 1400 from the liquid intake channel 100, or to communicate the multiple liquid discharge channels 1400 with the liquid intake channel 100.

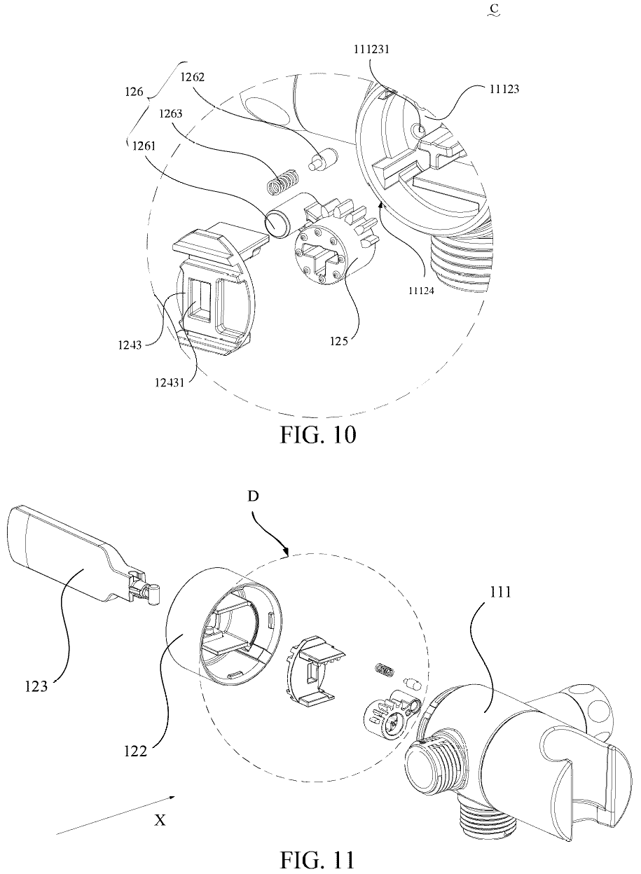

In an exemplary embodiment, referring to FIGS. 10 to 12 together, a first sliding part 1221 extending in a first direction is provided on the connection element 122, and a second sliding part 1241 slidably mated with the first sliding part 1221 is provided on the transmission element 124. The transmission element 124 may slide with respect to the connection element 122 through the mating between the first sliding part 1221 and the second sliding part 1241, so as to be able to transfer the driving force of the driving element 123 to the movable assembly 112, so that the movable assembly 112 is rotated. In this way, the mating between the first sliding part 1221 and the second sliding part 1241 may improve the movement accuracy of the transmission element 124, thereby ensuring the transmission stability between the driving element 123 and the movable assembly 112. One of the first sliding part 1221 and the second sliding part 1241 has a chute, and the other of the first sliding part 1221 and the second sliding part 1241 may be inserted into the chute, which may increase a connection area between the first sliding part 1221 and the second sliding part 1241 and play a position limiting role, so as to prevent the transmission element 124 from moving away from the first direction, and further improve the movement accuracy of the transmission element 124. In an embodiment of the present disclosure, the second sliding part 1241 has a chute, and the first sliding part 1221 may be inserted into the chute. The first direction is parallel to a direction pointed by an arrow X in FIG. 11.

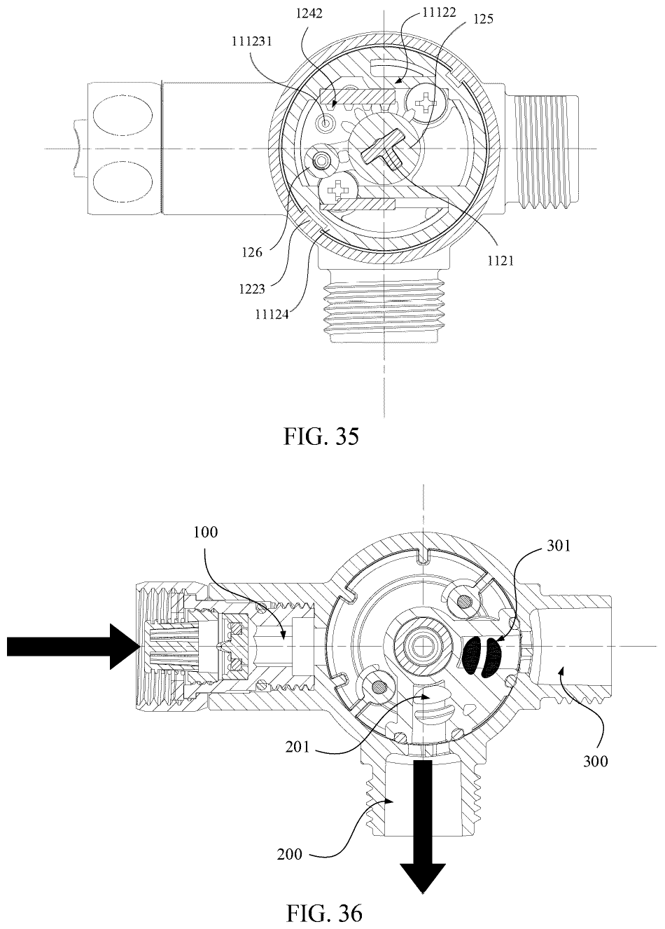

In an exemplary embodiment, referring to FIGS. 10, 12, 16, 18, 22, 23, 29, 35 and 38 together, the transmission element 124 has a rack 1242, and the operation mechanism 12 further includes a gear element 125 having a gear face, the gear element 125 and the movable assembly 112 are detachably connected and capable of anti-rotation cooperating. The movable assembly 112 is in transmission connection with the transmission element 124 by engaging the gear face with the rack 1242. In this way, the stable transmission of the driving force may be achieved by the cooperation between the rack 1242 and the gear face, and the driving force may be transmitted to the movable assembly 112 through the gear face so as to drive the movable assembly 112 to rotate. The driving element 123 moves relative to the connection element 122 to drive the transmission element 124, so that the transmission element 124 may slide relative to the connection element 122 through the cooperation between the first sliding part 1221 and the second sliding part 1241, and the rack 1242 may drive the gear face to roll relative to the rack 1242, so as to convert a linear motion of the transmission element 124 into a rotational motion of the gear face, thereby driving the rotational motion of the movable assembly 112. A labor-saving and convenient liquid path switching is achieved.

It may be understood that in other embodiments, the movable assembly 112 has the gear face. The transmission element 124 may be in direct transmission with the movable assembly 112 through the rack 1242.

In an exemplary embodiment, referring to FIGS. 29, 35, and 38 together, the transmission element 124 is slidably connected to the main body assembly 111 to improve a position stability of a side of the transmission element 124 away from the first sliding part 1221, and further improve the stability of the movement of the transmission element 124. The main body assembly 111 abuts against a side of the transmission element 124 facing away from the rack 1242, so that the rack 1242 and the gear face may be closely cooperated, and the cooperation accuracy and the transmission stability are improved. In an embodiment of the present disclosure, a sprung arm 11122 is provided on the liquid dispensing element 1112 so as to be able to elastically abut against a side of the transmission element 124 facing away from the rack 1242.

In an exemplary embodiment, referring to FIGS. 10, 12, 16, 18, 22, 23, 28, 29, 32, 35 and 38 together, the operation mechanism 12 further includes a second positioning assembly 126. A second positioning assembly 126 is provided on one of the main body assembly 111 and the gear element 125, and a second positioning element 11123 is provided on the other of the main body assembly 111 and the gear element 125. Optionally, a second positioning assembly 126 is provided on one of the main body assembly 111 and the movable assembly 112, and a second positioning element 11123 is provided on the other of the main body assembly 111 and the movable assembly 112. Multiple second positioning parts 111231 are provided on the second positioning element 11123, and the multiple second positioning parts 111231 are configured to cooperate with the second positioning assembly 126 for positioning under different communication or discommunication states between the liquid intake channel 100 and the multiple liquid discharge channels 1400 respectively.

In an embodiment of the present disclosure, three second positioning parts 111231 corresponding to the first position, the second position, and the third position are provided on the second positioning element 11123 to cooperate with the second positioning assembly 126 when the movable assembly 112 rotates to the first position, the second position, and the third position, and to realize a position feedback to prompt the rotation position of the movable assembly 112. The second positioning assembly 126 is provided at the gear element 125, and the main body assembly 111 is provided with the second positioning element 11123.

In an exemplary embodiment, referring to FIGS. 10, 12, 16, 18, 22, 23 and 32 together, the second positioning assembly 126 includes an installation component 1261, an abutment component 1262, and an elastic component 1263. The installation component 1261 is provided with a first installation space 12610, the abutment component 1262 is partially located in the first installation space 12610 and capable of slidably connecting with the second positioning element 11123. The elastic component 1263 is installed in the first installation space 12610 and capable of abutting the abutment component 1262 against the second positioning element 11123, so that a cooperation between the abutment component 1262 and the second positioning element 11123 may be tighter by an arrangement of the elastic component 1263, and a gap between the abutment component 1262 and the second positioning element 11123 may be avoided, which results in abnormal noise generated when the abutment component 1262 slides relative to the second positioning element 11123.

In an embodiment of the present disclosure, the second positioning part 111231 has a groove structure, and the elastic component 1263 may further enable the abutment component 1262 to be relatively stable in the groove structure, so as to improve the accuracy of the position feedback. The elastic component 1263 may be, but is not limited to, a metal spring element and a plastic spring.

The elastic component 1263 is installed in the first installation space 12610, so that an extension and retraction of the elastic component 1263 has a certain directionality. The abutment component 1262 has a columnar structure and a spherical crown. The abutment component 1262 is partially located in the first installation space 12610, and may improve a movement accuracy under a restriction of the installation component 1261. An arrangement of the spherical crown enables the abutment component 1262 to slide more smoothly relative to the second positioning element 11123, thus avoiding an occurrence of a jamming phenomenon.

In an embodiment of the present disclosure, the installation component 1261 has a columnar structure and is provided on the gear element 125. The liquid dispensing element 1112 is provided with the second positioning part 111231.

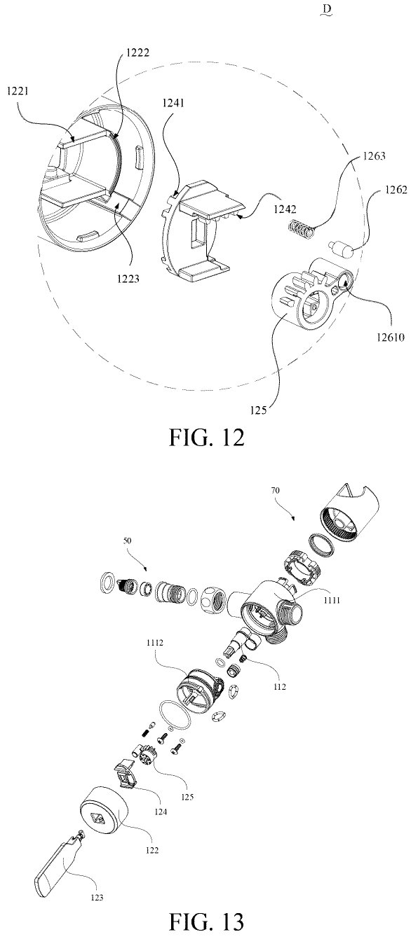

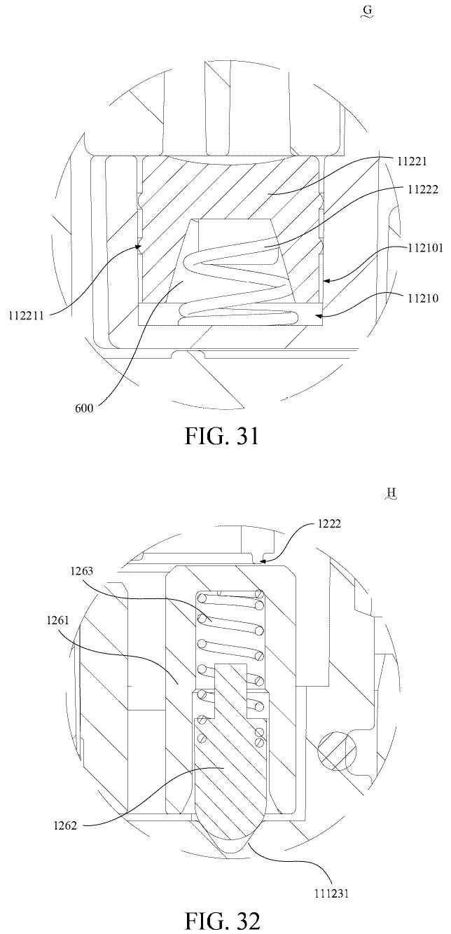

In an exemplary embodiment, referring to FIGS. 12 and 32 together, an abutment part 1222 is further provided on the connection element 122. The second positioning assembly 126 is provided on the gear element 125 or the movable assembly 112, and the abutment part 1222 abuts against a side of the second positioning assembly 126 facing away from the second positioning element 11123. In this way, a position stability of the second positioning assembly 126 may be improved, and a cooperation stability between the second positioning assembly 126 and the second positioning element 11123 may be ensured.

Optionally, the second positioning element 11123 is provided on the gear element 125 or the movable assembly 112, and the abutment part 1222 abuts against a side of the second positioning element 11123 facing away from the second positioning assembly 126. In this way, a position stability of the second positioning element 11123 may be improved, and a cooperation stability between the second positioning assembly 126 and the second positioning element 11123 may be ensured.

In an embodiment of the present disclosure, the second positioning assembly 126 is provided on the gear element 125, and the abutment part 1222 abuts against a side of the second positioning assembly 126 facing away from the second positioning element 11123. The abutment part 1222 may extend along the movement trajectory of the second positioning assembly 126 so that the second positioning assembly 126 may always be abutted by the abutment part 1222 during a movement process.

In an exemplary embodiment, referring to FIGS. 10, 12, 29, 35 and 38 together, a first limiting part 1223 is provided on the connection element 122, a second limiting part 11124 that is in limiting cooperation with the first limiting part 1223 is provided on the main body assembly 111, so that a limiting cooperation between the first limiting part 1223 and the second limiting part 11124 may prevent the connection element 122 from rotating relative to the main body assembly 111, so as to ensure the cooperation accuracy between the driving element 123, the transmission element 124, and the movable assembly 112. In an embodiment of the present disclosure, the connection element 122 may be clamped with the main body assembly 111, and the connection element 122 and the main body assembly 111 may be separated by the elastic deformability of at least one of the connection element 122 and the main body assembly 111.

In an exemplary embodiment, referring to FIGS. 7, 8, 11, 13 to 16 and 18 to 20B together, the driving element 123 may be swung relative to the connection element 122 so as to drive the movable assembly 112 to rotate relative to the main body assembly 111 by the transmission element 124. In this way, the driving element 123 forms a structure that may be swung relative to the connection element 122, and may cooperate with the connection element 122 to form a labor-saving lever structure, which is convenient to drive the transmission element 124, so that the movable assembly 112 may rotate relative to the main body assembly 111. In some exemplary embodiments, the transmission element 124 has a rack 1242, the movable assembly 112 has a gear face or the operation mechanism 12 further includes a gear element 125 with a gear face, and the above-mentioned lever structure may also compensate for a problem that a torque of a gear pair formed by the rack 1242 and the gear face cannot increase insufficient switching force under the limiting of the shape of the liquid dispensing device 10. The liquid path is switched by a swinging mode, and a swinging motion of the driving element 123 is converted into a linear motion of the transmission element 124, and the linear motion of the transmission element 124 is converted into a rotational motion of the movable assembly 112, thereby realizing a labor-saving and convenient liquid path switching.

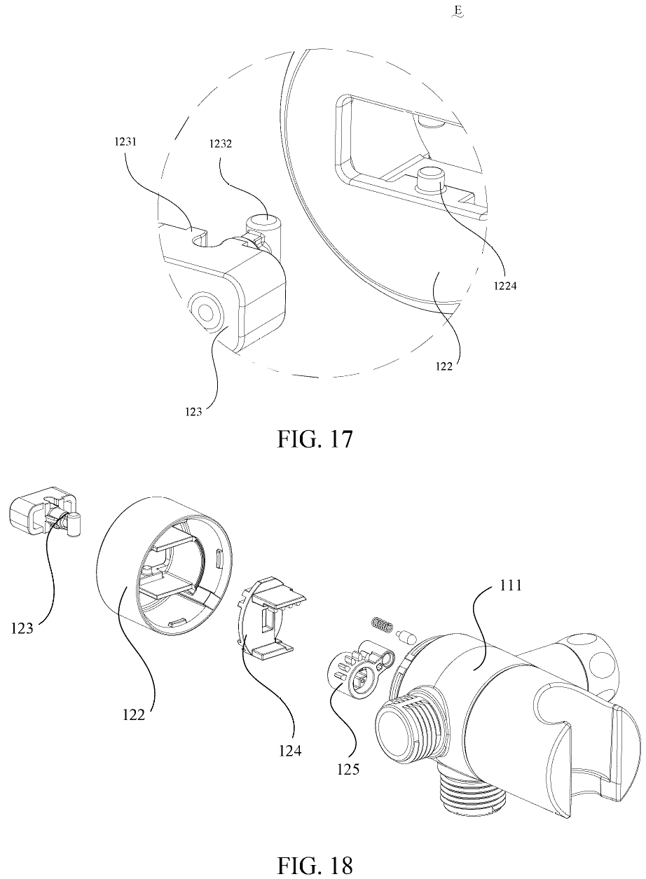

In an exemplary embodiment, referring to FIGS. 9, 12 and 17 together, one of the connection element 122 and the driving element 123 is provided with a rotary shaft 1224, the other of the connection element 122 and the driving element 123 may be rotatably connected to the rotary shaft 1224, so that the driving element 123 may be swung relative to the connection element 122. In this way, an arrangement of the rotary shaft 1224 may improve the stability of the swinging of the driving element 123 relative to the connection element 122, and a lever fulcrum structure formed at a position of the rotary shaft 1224 is more stable, thereby improving the stability of driving the transmission element 124. In an embodiment of the present disclosure, the rotary shaft 1224 is provided on the connection element 122, and the driving element 123 is rotatably connected to the rotary shaft 1224.

In an exemplary embodiment, referring to FIGS. 9, 12, and 17 together, the other of the connection element 122 and the driving element 123 may be detachably connected to the rotary shaft 1224 to facilitate updating, upgrading, changing or replacement due to damage of the driving element 123. In an embodiment of the present disclosure, the driving element 123 may be detachably connected to the rotary shaft 1224. The driving element 123 is provided with a clamp opening part 1231 to facilitate clamping with and separating from the rotary shaft 1224.

In an exemplary embodiment, referring to FIGS. 9, 10, 12 and 17 together, the driving element 123 has a first driving part 1232, and the transmission element 124 has a second driving part 1243. One of the first driving part 1232 and the second driving part 1243 is a protrusion, and the other of the first driving part 1232 and the second driving part 1243 has a groove wall 12431 that encloses and forms a groove. The protrusion may be accommodated in the groove and is in transmission cooperation with the groove wall 12431, so that the groove wall 12431 may limit the protrusion, so as to prevent the driving element 123 from separating from the transmission element 124 during swinging process, and further improve the transmission stability between the driving element 123 and the transmission element 124. Meanwhile, the groove may avoid the protrusion, thereby avoiding interference on the motion of the first driving part 1232 and the second driving part 1243, and avoiding an occurrence of a jamming phenomenon. In an embodiment of the present disclosure, the first driving part 1232 is a protrusion. The second driving part 1243 has a groove wall 12431 that encloses and forms a groove.

In an exemplary embodiment, referring to FIGS. 9, 10, 12, 17, 28, 30, 34, and 37 together, a side of the first driving part 1232 that is in transmission cooperation with the groove wall 12431 is an arc-shaped surface 12321, so that there is a line-surface mating between the first driving part 1232 and the groove wall 12431, and a contact area between the first driving part 1232 and the groove wall 12431 may be reduced, thereby making the transmission smoother and further avoiding an occurrence of a jamming phenomenon. In an embodiment of the present disclosure, the first driving part 1232 is cylindrical.

In an exemplary embodiment, referring to FIGS. 1, 7, 8, 11, 13, 14A, 14B, 28, 30, 34, and 37 together, the driving element 123 is a shifter lever, which may form a more labor-saving lever structure and facilitate labor-saving and convenient liquid path switching. The shifter lever swings relative to the connection element 122, and the transmission element 124 is driven by a cooperation between the first driving part 1232 and the second driving part 1243, so that the transmission element 124 may slide relative to the connection element 122 by a cooperation between the first sliding part 1221 and the second sliding part 1241, and the rack 1242 may drive the gear face to roll relative to the rack 1242, so as to convert the linear motion of the transmission element 124 into a rotational motion of the gear face, thereby driving the rotation motion of the movable assembly 112, and realizing a labor-saving and convenient liquid path switching. The swinging of the shifter lever relative to the connection element 122 in a direction includes swinging in a horizontal direction, swinging in a vertical direction, or swinging in a direction at a certain angle with the horizontal plane, so as to meet different usage requirements of the user.

While the communication state between the liquid intake channel 100 and the multiple liquid discharge channels 1400 is changed by the swinging of the shifter lever, the swinging position of the shifter lever may provide a more obvious indication of the communication state, thus improving the user experience.

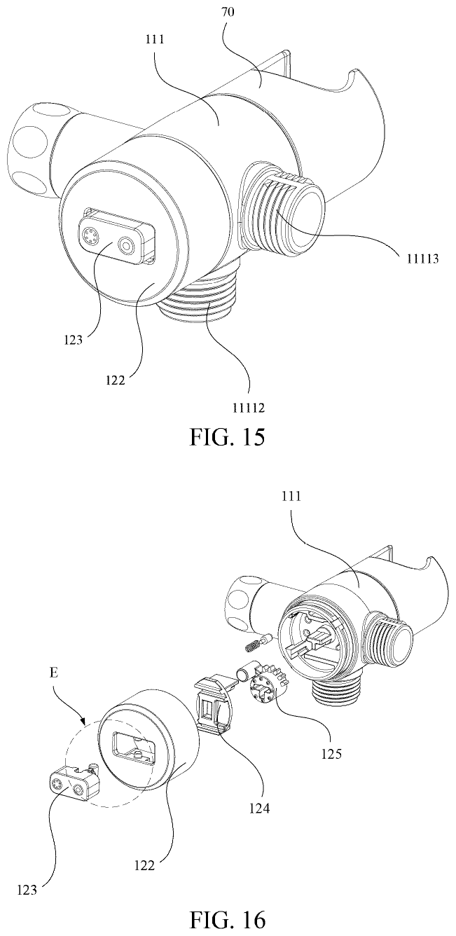

In an exemplary embodiment, referring to FIGS. 15 to 20B together, the driving element 123 is a rocker switch, which may realize the switching of the liquid path by pressing, so that a structure of the liquid dispensing device 10 is more compact and delicate. The rocker switch swings with respect to the connection element 122, and the transmission element 124 is driven by a cooperation between the first driving part 1232 and the second driving part 1243, so that the transmission element 124 may slide relative to the connection element 122 through a cooperation between the first sliding part 1221 and the second sliding part 1241, and the rack 1242 may drive the gear face to roll relative to the rack 1242, so as to convert a linear motion of the transmission element 124 into a rotational motion of the gear face, thereby driving the rotational motion of the movable assembly 112, and a labor-saving and convenient liquid path switching is achieved. The swinging of the rocker switch relative to the connection element 122 in a direction includes swinging in a horizontal direction, swinging in a vertical direction, or swinging in a direction at a certain angle with the horizontal plane, so as to meet different usage requirements of the user.

In an exemplary embodiment, referring to FIGS. 21 to 25 together, the driving element 123 is a push button, the push button is slidable relative to the connection element 122 so as to drive the movable assembly 112 to rotate relative to the main body assembly 111 by the transmission element 124. The push button may realize the switching of the liquid path by pushing and pressing, so that a structure of the liquid dispensing device 10 is more compact and delicate. The push button slides relative to the connection element 122, and the transmission element 124 is driven by a cooperation between the first driving part 1232 and the second driving part 1243, so that the transmission element 124 may slide relative to the connection element 122 through the cooperation between the first sliding part 1221 and the second sliding part 1241, and the rack 1242 may drive the gear face to roll relative to the rack 1242, so as to convert a linear motion of the transmission element 124 into a rotational motion of the gear face, thereby driving the rotational motion of the movable assembly 112, and a labor-saving and convenient liquid path switching is achieved. The sliding of the push button relative to the connection element 122 in a direction includes sliding in a horizontal direction, sliding in a vertical direction, or sliding in a direction at a certain angle with the horizontal plane, so as to meet different usage requirements of the user. The transmission element 124 is connected with the push button to transmit the driving force of the push button to the movable assembly 112 to rotate the movable assembly 112.

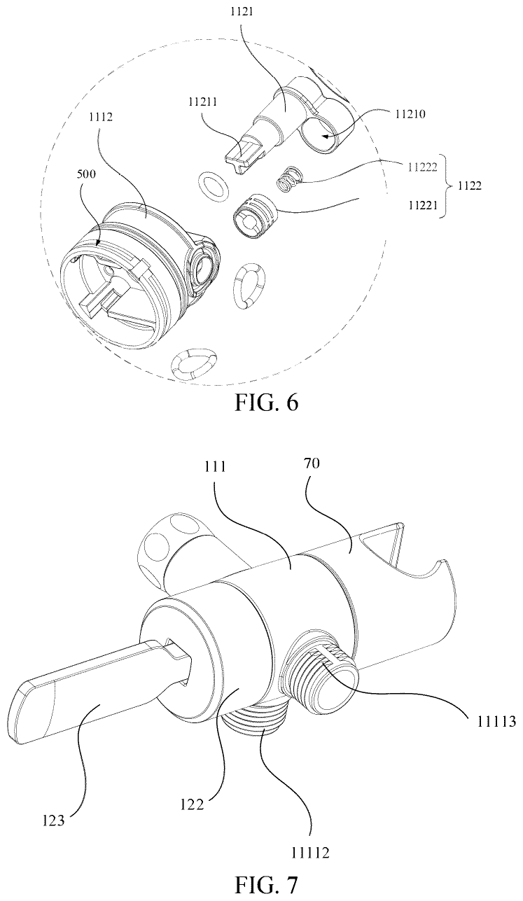

In an exemplary embodiment, referring to FIGS. 6, 10, 16, 22, 26, 27, 30, 31, 33, 36 and 39 together, the movable assembly 112 includes a rotation element 1121 and a sealing element 1122. The rotation element 1121 is rotatably connected to the main body assembly 111, and the sealing element 1122 is provided on the rotation element 1121. The operation mechanism 12 may drive the rotation element 1121 to rotate relative to the main body assembly 111 so that the sealing element 1122 slides relative to the main body assembly 111. In this way, when the rotation element 1121 moves relative to the main body assembly 111, the scaling element 1122 may slide relative to the main body assembly 111 while maintaining the fit between the sealing element 1122 and the main body assembly 111. In an embodiment of the present disclosure, the sealing element 1122 is fitted to the liquid dispensing element 1112 and may slide relative to the liquid dispensing element 1112 when the rotation element 1121 rotates relative to the main body assembly 111.

During a rotation process of the rotation element 1121 relative to the main body assembly 111, the sealing element 1122 is capable of closing at least one of the multiple liquid discharge channels 1400 to discommunicate at least one of the multiple liquid discharge channels 1400 from the liquid intake channel 100, or exposing the multiple liquid discharge channels 1400 on the main body assembly 111 to communicate the multiple liquid discharge channels 1400 with the liquid intake channel 100.

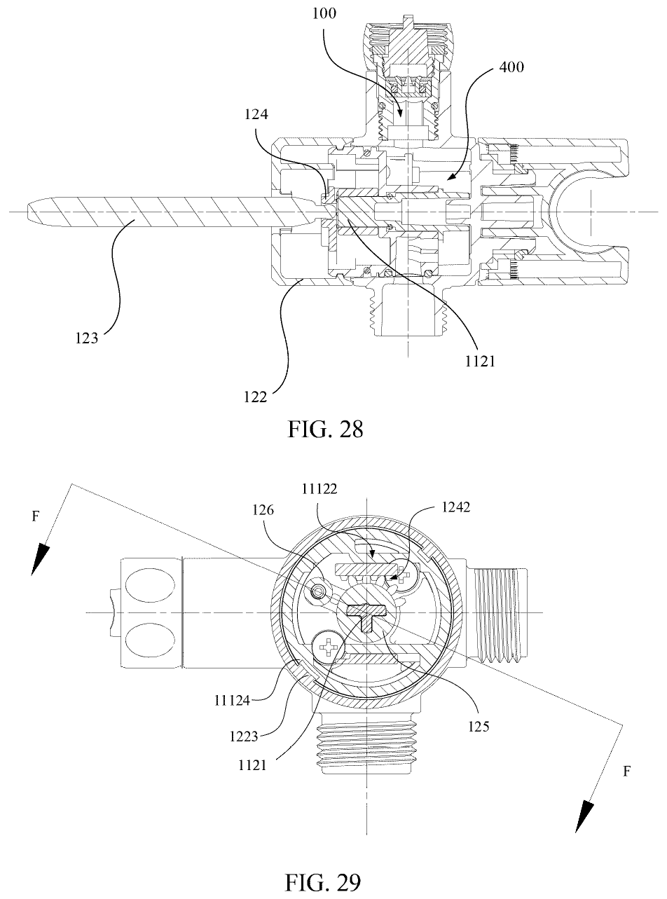

As shown in FIGS. 28, 29, 30, and 33, at a first position, the sealing element 1122 closes a portion of the first liquid discharge hole 201 and a portion of the second liquid discharge hole 301 so that the liquid intake channel 100 may communicate with the first liquid discharge channel 200 and the second liquid discharge channel 300, respectively, and the first liquid discharge channel 200 and the second liquid discharge channel 300 may simultaneously discharge liquid.

As shown in FIGS. 34 to 36, at a second position, the sealing element 1122 closes the second liquid discharge hole 301 so that the liquid intake channel 100 communicates with the first liquid discharge channel 200, thereby enabling the first liquid discharge channel 200 to discharge liquid.

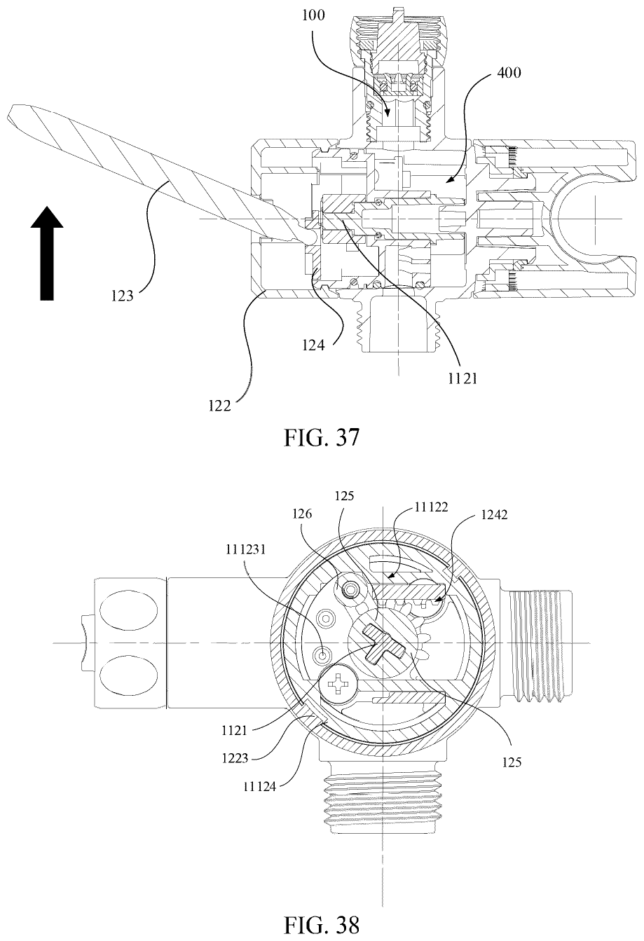

As shown in FIGS. 37 to 39, at a third position, the sealing element 1122 closes the first liquid discharge hole 201 so that the liquid intake channel 100 communicates with the second liquid discharge channel 300, thereby enabling the second liquid discharge channel 300 to discharge liquid.

In addition, in some exemplary embodiments, the sealing element 1122 may also close the first liquid discharge hole 201 and the second liquid discharge hole 301 simultaneously, so that the liquid intake channel 100 may be discommunicated from both the first liquid discharge channel 200 and the second liquid discharge channel 300, and the first liquid discharge channel 200 and the second liquid discharge channel 300 may simultaneously not discharge liquid.

It can be understood that in other embodiments, the rotation trajectory of the movable assembly 112 rotating relative to the main body assembly 111 may further include other positions for the switching of other liquid paths.

In an exemplary embodiment, referring to FIGS. 6, 26, 27, 30 and 31 together, the scaling element 1122 includes a flexible part 11221 and an elastic part 11222. The flexible part 11221 may be elastically abutted against the main body assembly 111 and the flexible part 11221 may be better fitted against the main body assembly 111 by deforming itself to ensure a tighter fit between the sealing element 1122 and the main body assembly 111. The elastic part 11222 is supported between the rotation element 1121 and the flexible part 11221 to further enhance an elastic abutment force of the flexible part 11221 acting on the main body assembly 111, thereby further ensuring a tighter fit between the sealing element 1122 and the main body assembly 111, ensuring a reliability of a subsequent closing of the first liquid discharge channel 200 or the second liquid discharge channel 300, and ensuring the stability of the liquid path switching. The flexible part 11221 may be made of, but is not limited to, an elastomer material. The elastic part 11222 may be made of, but is not limited to, a metal spring element and a plastic spring.

In an exemplary embodiment, as shown in FIGS. 6, 27, and 31, a second installation space 11210 is provided on the rotation element 1121, and the elastic part 11222 is installed in the second installation space 11210, so that the extension and retraction of the elastic part 11222 has a certain directionality. The flexible part 11221 is partially accommodated in the second installation space 11210. In this way, a connection area between the flexible part 11221 and the rotation element 1121 is increased, and the connection stability between the flexible part 11221 and the rotation element 1121 is increased.

In an exemplary embodiment, as shown in FIGS. 6, 27, and 31, an accommodation groove 600 is provided on a side of the flexible part 11221 facing away from the main body assembly 111, and an elastic part 11222 is partially accommodated in the accommodation groove 600, so that the flexible part 11221 may be abutted against the hole wall 112101 of the second installation space 11210, and the connection stability between the flexible part 11221 and the rotation element 1121 may be further improved. In an embodiment of the present disclosure, the accommodation groove 600 is a tapered hole, and the elastic part 11222 is partially accommodated in the accommodation groove 600 and expands the flexible part 11221 toward the hole wall 112101, thereby further improving the connection stability between the flexible part 11221 and the rotation element 1121.

In an exemplary embodiment, as shown in FIGS. 6, 27, and 31, the flexible part 11221 is provided with an arc-shaped protrusion 112211 and the arc-shaped protrusion 112211 abuts against the hole wall 112101. In this way, under an action of the flexible part 11221 and the elastic part 11222, the arc-shaped protrusion 112211 may be more closely fitted against the hole wall 112101, and the flexible part 11221 may be more stably installed in the second installation space 11210.

The liquid dispensing device enables at least one of different liquid discharge elements of a liquid discharge system to discharge liquid by changing a flow direction of the liquid, so as to meet the usage requirements of the user.

Some liquid dispensing devices adopt a transmission element to transmit the driving force. The inventors of the present disclosure found that an installation of the transmission element in the liquid dispensing device is inconvenient because the transmission element is generally installed inside the liquid dispensing device, and an installation position is limited, which is not convenient for the installation for the transmission element.

An embodiment of the present disclosure further provides a liquid dispensing device and a liquid discharge system. The liquid discharge system may be installed in various occasions and environments, such as companies, schools, families, factories and the like, to realize cleaning effect and improve and enhance life quality and health of people. The liquid discharge system may be, but is not limited to, one or more combinations of a water outlet faucet, a shower head, a top sprayer and a spray gun. In order to facilitate the description of the technical solution of the present disclosure, illustration is made below by taking a case in which a liquid discharge system is a shower kit consisting of a shower head and a top sprayer as an example.

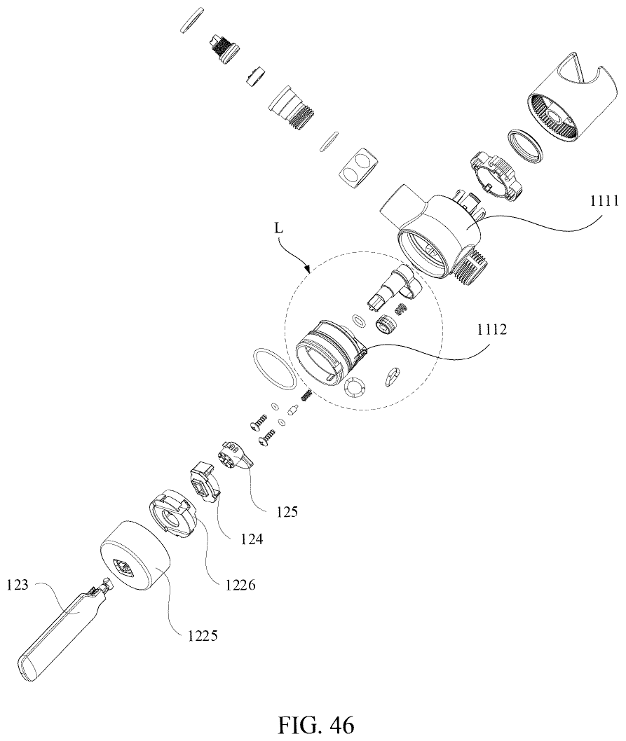

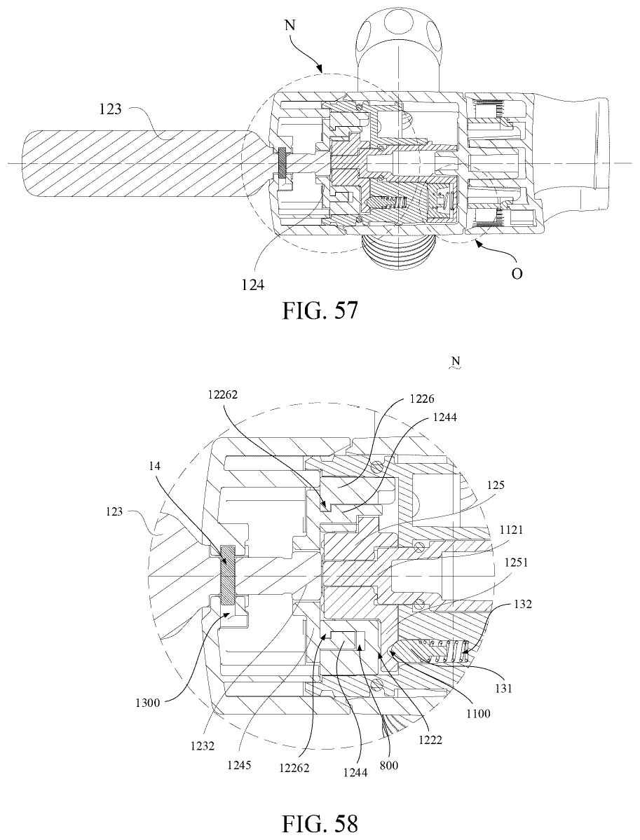

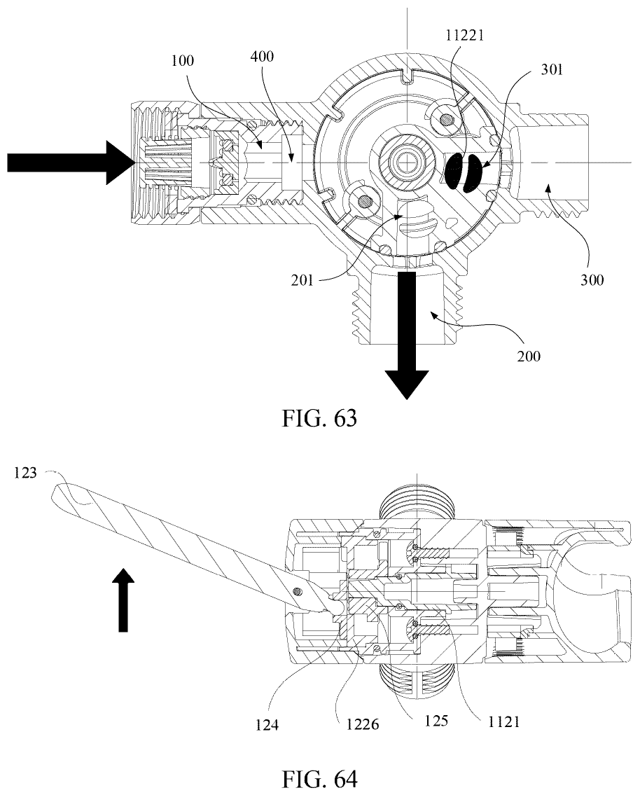

Referring to FIGS. 1, 40, 41, 43 to 46, 55, 57, 58, 60, 61, 63, 64 and 66 together, the liquid discharge system provided by an embodiment of the present disclosure will now be described. The liquid discharge system includes a liquid dispensing device 10 and multiple liquid dispensing elements. The liquid dispensing device 10 includes a liquid dispensing mechanism 11 and an operation mechanism 12. The liquid dispensing mechanism 11 includes a main body assembly 111 and a movable assembly 112. The main body assembly 111 is provided with a liquid intake channel 100 and multiple liquid discharge channels 1400, and the movable assembly 112 is movably installed to the main body assembly 111. The multiple liquid discharge elements are communicated in one-to-one correspondence with the multiple liquid discharge channels 1400.

The operation mechanism 12 is detachably connected to the liquid dispensing mechanism 11. The operation mechanism 12 includes a connection element 122, a driving element 123, and a transmission element 124. The connection element 122 includes an outer housing 1225 and an inner core 1226 that are detachably connected. The inner core 1226 is installed to the outer housing 1225. The transmission element 124 is movably installed between the outer housing 1225 and the inner core 1226, and the outer housing 1225 is detachably connected to the main body assembly 111. The driving element 123 is movably connected to the outer housing 1225, and the driving element 123 is movable relative to the outer housing 1225, and drives the movable assembly 112 to rotate relative to the main body assembly 111 through the transmission element 124, so as to discommunicate at least one of the multiple liquid discharge channels 1400 from the liquid intake channel 100, or to communicate the multiple liquid discharge channels 1400 with the liquid intake channel 100.

In an embodiment of the present disclosure, the multiple liquid dispensing elements include a shower head 20 and a top sprayer 30. A quantity of liquid discharge channels 1400 is two, including a first liquid discharge channel 200 in communication with the shower head 20 and a second liquid discharge channel 300 in communication with the top sprayer 30. A rotation trajectory of the movable assembly 112 rotating relative to the main body assembly 111 includes at least a first position, and a second position and a third position located on two sides of the first position. At the first position, the first liquid discharge channel 200 and the second liquid discharge channel 300 simultaneously discharge liquid. At the second position, the first liquid discharge channel 200 discharges liquid. At the third position, the second liquid discharge channel 300 discharges liquid.

The liquid discharge system further includes a supporting liquid intake assembly 40. A liquid intake assembly 50 communicating between the supporting liquid intake assembly 40 and the liquid intake channel 100 is provided on the liquid dispensing mechanism 11. A first connection part 11111 connected to the liquid intake assembly 50 is provided on the liquid dispensing mechanism 11. The first connection part 11111 may be connected to the liquid intake assembly 50 by, but not limited to, threaded connection, plug connection, clamping connection, or welding. The liquid dispensing device 10 is provided on the wall by the supporting liquid intake assembly 40. The supporting liquid intake assembly 40 is configured to be capable of providing liquid to the liquid intake channel 100. The supporting liquid intake assembly 40 may have, but is not limited to have, a manually controlled or an electrically controlled valve structure, and the liquid intake channel 100 is communicated with or discommunicated from a liquid source by controlling an opening or closing of the supporting liquid intake assembly 40. The liquid includes, but is not limited to, clear water or pure water from a municipal water network.

A second connection part 11112 is provided on the liquid dispensing mechanism 11. The second connection part 11112 may be connected to a hose 60 by means of, but not limited to, threaded connection, plug connection, clamping connection, or welding, and is in communication with the shower head 20 through the hose 60, so that the shower head 20 is in communication with the first liquid discharge channel 200.

A third connection part 11113 is provided on the liquid dispensing mechanism 11. The third connection part 11113 may be connected to the top sprayer 30 by, but not limited to, threaded connection, plug connection, clamping connection, or welding, so as to realize connection between the top sprayer 30 and the second liquid discharge channel 300.

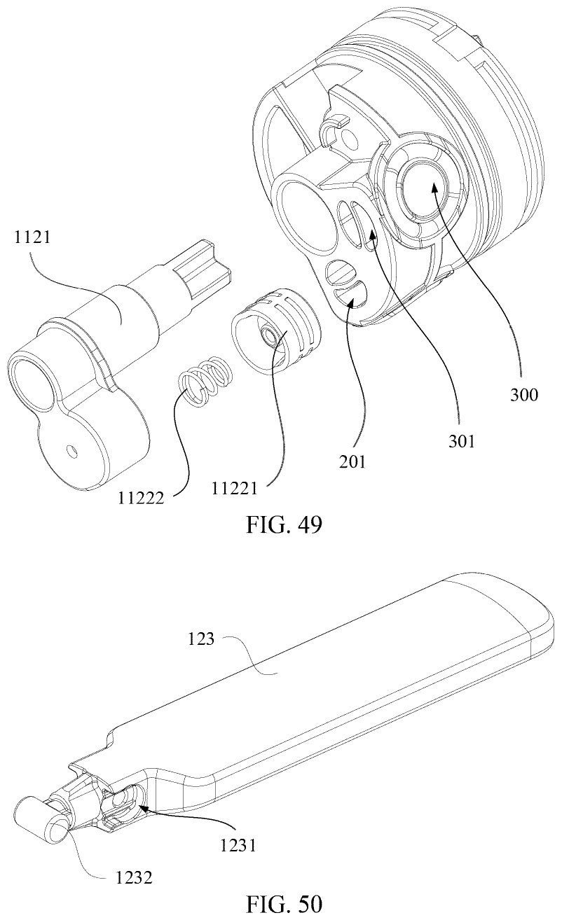

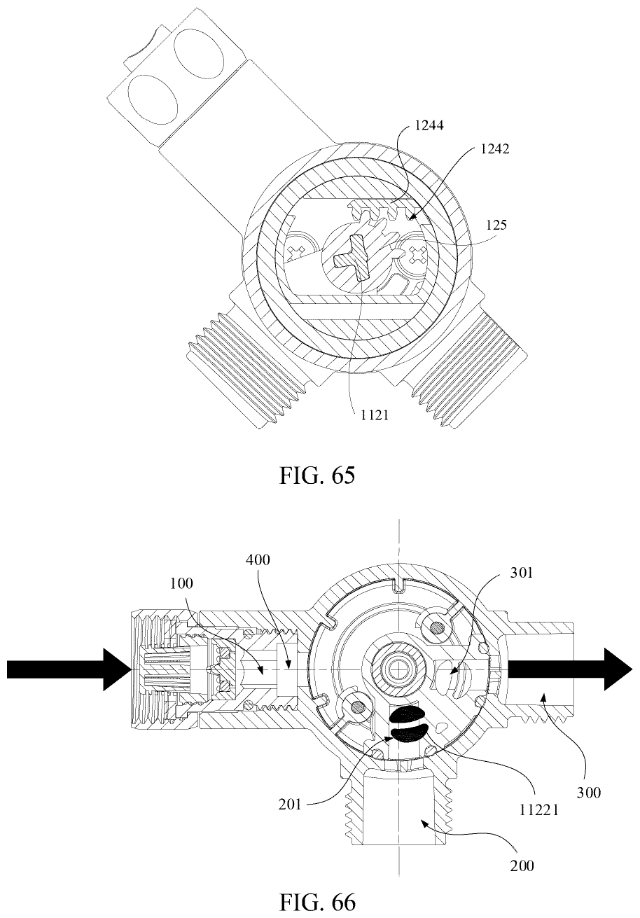

In an exemplary embodiment, referring to FIGS. 40, 41, 44, 46-49, 55-57, and 60-66 together, the main body assembly 111 includes a housing 1111 and a liquid dispensing element 1112. The liquid dispensing element 1112 is detachably connected to and installed in the housing 1111 or integrally provided with the housing 1111. The first connection part 11111, the second connection part 11112, and the third connection part 11113 are provided on the housing 1111. The housing 1111 and the liquid dispensing element 1112 enclose and form a liquid intake cavity 400 communicated with the liquid intake channel 100. The first liquid discharge channel 200 may form a first liquid discharge hole 201 on the liquid dispensing element 1112. The second liquid discharge channel 300 may form a second liquid discharge hole 301 on the liquid dispensing element 1112.

The driving element 123 drives the movable assembly 112 to rotate with respect to the main body assembly 111 through the transmission element 124, so as to discommunicate at least one of the first liquid discharge hole 201 and the second liquid discharge hole 301 from the liquid intake cavity 400, or to communicate both the first liquid discharge hole 201 and the second liquid discharge hole 301 with the liquid intake cavity 400. Thereby, at least one of the first liquid discharge channel 200 and the second liquid discharge channel 300 is discommunicated from the liquid intake channel 100, or both the first liquid discharge channel 200 and the second liquid discharge channel 300 are communicated with the liquid intake channel 100.

The driving element 123 drives the movable assembly 112 to rotate with respect to the main body assembly 111 through the transmission element 124, so as to discommunicate at least one of the first liquid discharge channel 200 and the second liquid discharge channel 300 from the liquid intake channel 100, or to communicate both the first liquid discharge channel 200 and the second liquid discharge channel 300 with the liquid intake channel 100. That is, it can be switched between a mode of the shower head 20 discharging liquid, a mode of the top sprayer 30 discharging liquid, a mode of both the shower head 20 and the top sprayer 30 not discharging liquid, and a mode of both the shower head 20 and the top sprayer 30 discharging liquid. The liquid dispensing mechanism 11 is further provided with a fixation structure 70, which may be detachably connected with the shower head 20.

In summary, the implementation of embodiments of the present disclosure has the following beneficial effects: the liquid dispensing device 10 of the above-mentioned solution is applied to and installed in the liquid discharge system, and in addition to realizing the effect of switching liquid discharge of different liquid discharge elements of the liquid discharge system, it can also facilitate the installation of the transmission element 124 and improve the assembly efficiency. Specifically, the liquid dispensing device 10 includes a liquid dispensing mechanism 11 and an operation mechanism 12. The liquid dispensing mechanism 11 includes a main body assembly 111 provided with a liquid intake channel 100 and multiple liquid discharge channels 1400, and a movable assembly 112 movably installed to the main body assembly 111. The operation mechanism 12 includes a connection element 122, a driving element 123, and a transmission element 124. The connection element 122 includes an outer housing 1225 and an inner core 1226 that are detachably connected, and the transmission element 124 is movably installed between the outer housing 1225 and the inner core 1226, so that the installation of the transmission element 124 is convenient and the assembly efficiency is improved. Moreover, the outer housing 1225 and the inner core 1226 may restrict the transmission element 124 from two sides, thus improving the connection stability between the transmission element 124 and the connection element 122, and ensuring the transmission stability of the transmission element 124. The driving element 123 is capable of driving the movable assembly 112 to rotate relative to the main body assembly 111 through the transmission element 124, so as to discommunicate at least one of the multiple liquid discharge channels 1400 from the liquid intake channel 100, or to communicate the multiple liquid discharge channels 1400 with the liquid intake channel 100. In this way, by rotating the movable assembly 112 relative to the main body assembly 111, the communication state between the liquid intake channel 100 and the multiple liquid discharge channels 1400 may be changed, and different liquid discharge channels 1400 may be switched to discharge liquid or all the liquid discharge channels 1400 may be closed simultaneously according to specific usage requirements.

The outer housing 1225 is detachably connected to the main body assembly 111 to facilitate the disassembly and connection of the operation mechanism 12 and the liquid dispensing mechanism 11. After installation, the inner core 1226 and the transmission element 124 may be detachably connected to the main body assembly 111 together with the driving element 123 and the outer housing 1225. After installation, the inner core 1226 and the transmission element 124 may also be detachably connected to the main body assembly 111 first, and then detachably connected to the driving element 123 and the outer housing 1225 together with the main body assembly 111. In this way, when the operation mechanism 12 or the liquid dispensing mechanism 11 is updated and upgraded, it is not necessary to make a mold for the whole liquid separating device 10, thereby reducing the production cost caused by updating and upgrading. When the user wishes to upgrade and change an operation mode or a liquid dispensing mode and an operation structure or a liquid dispensing structure is damaged and needs to be replaced, the liquid dispensing device 10 does not need to be purchased as a whole, thereby reducing a cost of upgrading, changing and replacing the liquid dispensing device 10.

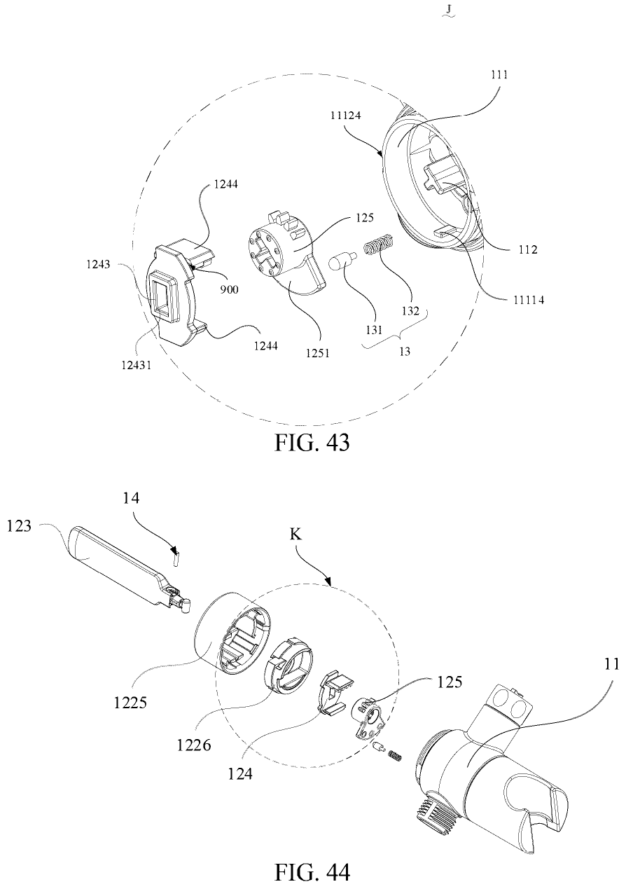

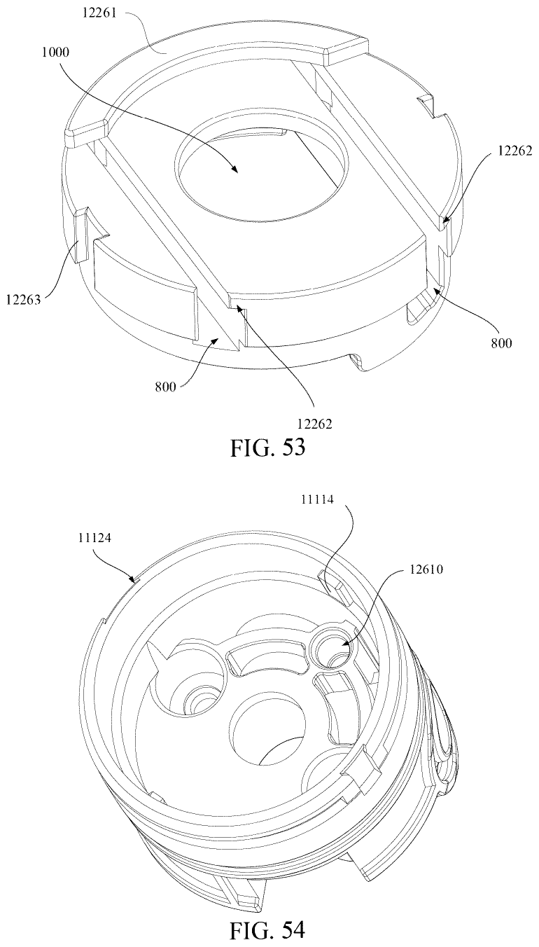

In an exemplary embodiment, referring to FIGS. 43, 45, 53, 56, 58, 62 and 65 together, the transmission element 124 includes multiple movement parts 1244, the inner core 1226 is provided with multiple sliding grooves 800 extending in a first direction, the multiple movement parts 1244 are accommodated in one-to-one correspondence in the multiple sliding grooves 800 and are capable of sliding relative to the inner core 1226 along the sliding grooves 800. At least one movement part 1244 is exposed to the inner core 1226 and is in transmission connection with the movable assembly 112. The transmission element 124 is capable of sliding relative to the inner core 1226 through the multiple movement parts 1244, so as to be able to transmit the driving force of the driving element 123 to the movable assembly 112 to rotate the movable assembly 112. In this way, the multiple movement parts 1244 may improve the movement accuracy of the transmission element 124, thereby ensuring the transmission stability between the driving element 123 and the movable assembly 112.

The multiple movement parts 1244 are accommodated in one-to-one correspondence in the multiple sliding grooves 800, which may increase a connection area between the movement parts 1244 and the inner core 1226 and play a position limiting role, so as to prevent the transmission element 124 from moving away from the first direction, and further improve the movement accuracy of the transmission element 124.

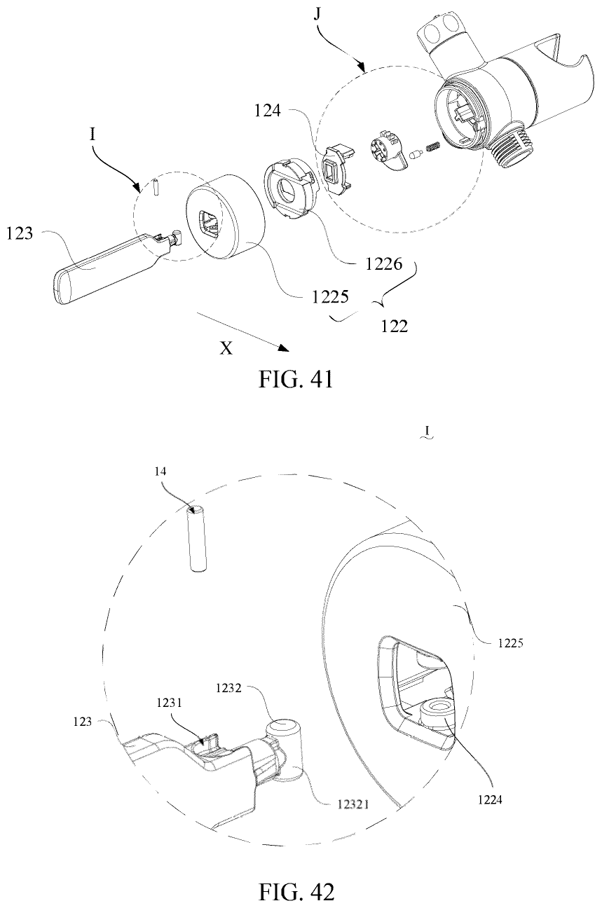

The multiple movement parts 1244 are accommodated in one-to-one correspondence in the multiple sliding grooves 800, and the transmission element 124 may be partially embedded in the inner core 1226. After being assembled with the inner core 1226, the transmission element 124 may be installed together with the inner core 1226 in the outer housing 1225 and then in the main body assembly 111, or the transmission element 124 together with the inner core 1226 may be first installed to the main body assembly 111 and then installed in the outer housing 1225, which facilitates the installation of the transmission element 124. Moreover, the outer housing 1225 and the inner core 1226 may restrict the transmission element 124 from two sides, thus improving the connection stability between the transmission element 124 and the connection element 122. In an embodiment of the present disclosure, the first direction is parallel to a direction pointed by an arrow X in FIG. 41.

The sliding groove 800 may penetrate at least one side of the inner core 1226 between two sides that are opposite to each other in the first direction, so that the movement part 1244 may be accommodated in the sliding groove 800. In an embodiment of the present disclosure, the sliding groove 800 may penetrate at least one side of the inner core 1226 between two sides that are opposite to each other in the first direction, and a limiting strip 12261 is provided on the other side. An arrangement of the limiting strip 12261 may reduce the risk of the movement part 1244 detaching from the sliding groove 800, and can improve the connection stability between the transmission element 124 and the inner core 1226 before the transmission element 124 and the inner core 1226 are installed to the outer housing 1225.

In an exemplary embodiment, referring to FIGS. 43, 45, 53, and 58 together, a first guiding part 900 is provided on the movement part 1244. The inner core 1226 is provided with a second guiding part 12262, which is located in the sliding groove 800. Both the first guiding part 900 and the second guiding part 12262 extend in the first direction, and one of the first guiding part 900 and the second guiding part 12262 may be accommodated in the other of the first guiding part 900 and the second guiding part 12262. In this way, an arrangement of the first guiding part 900 and the second guiding part 12262 may further increase a connection area between the movement part 1244 and the inner core 1226, thus improving the connection stability and movement accuracy, and further restricting a movement of the movement part 1244 relative to the inner core 1226 in a direction at an angle with the first direction, so as to ensure the transmission accuracy between the transmission element 124 and the movable assembly 112. In an embodiment of the present disclosure, the first guiding part 900 has a groove structure. The second guiding part 12262 has a protrusion structure.

In an exemplary embodiment, referring to FIGS. 43, 45, 47, 51, 53, and 54 together, a first limiting part 1223 is provided on the outer housing 1225, a second limiting part 11124 that is in limiting cooperation with the first limiting part 1223 is provided on the main body assembly 111, so that a limiting cooperation between the first limiting part 1223 and the second limiting part 11124 may prevent the outer housing 1225 from rotating relative to the main body assembly 111, so as to ensure the cooperation accuracy between the driving element 123, the transmission element 124, and the movable assembly 112. One of the first limiting part 1223 and the second limiting part 11124 has a protrusion structure, and the other of the first limiting part 1223 and the second limiting part 11124 has a groove structure. In an embodiment of the present disclosure, the first limiting part 1223 has a protrusion structure. The second limiting part 11124 has a groove structure. The outer housing 1225 is capable of being clamped with the main body assembly 111, and the outer housing 1225 and the main body assembly 111 may be separated by the elastic deformability of the outer housing 1225 and/or the main body assembly 111. The outer housing 1225 and/or the main body assembly 111 are further provided with a third limiting part 11114, and a fourth limiting part 12263 is provided on the inner core 1226. The fourth limiting part 12263 may cooperate with the third limiting part 11114 to prevent the inner core 1226 from rotating relative to the outer housing 1225 and the main body assembly 111, thereby ensuring a stable position of the inner core 1226, and further ensuring the transmission stability of the transmission element 124. One of the third limiting part 11114 and the fourth limiting part 12263 has a protrusion structure, and the other of the third limiting part 11114 and the fourth limiting part 12263 has a groove structure. In an embodiment of the present disclosure, the third limiting part 11114 is provided on the main body assembly 111 and has a protrusion structure. The fourth limiting part 12263 has a groove structure.

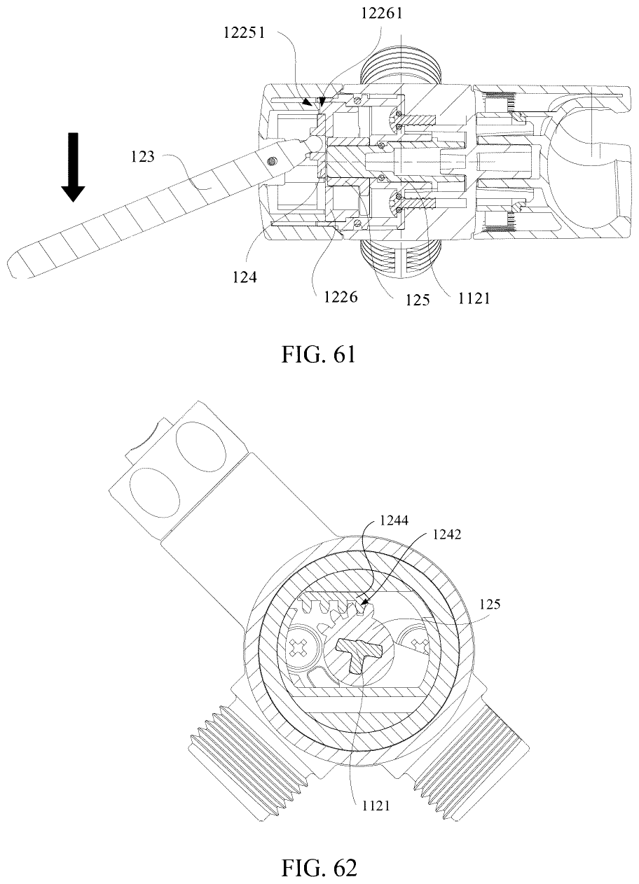

In an exemplary embodiment, referring to FIGS. 43, 45, 51, 58, 61, and 64 together, the transmission element 124 further includes a connection plate 1245, multiple movement parts 1244 are provided on the connection plate 1245, and a synchronization of the movement of multiple movement parts 1244 relative to the inner core 1226 may be ensured by an arrangement of the connection plate 1245. The outer housing 1225 is provided with multiple limiting protrusions 12251, and the multiple limiting protrusions 12251 are provided on the circumferential outer side of the transmission element 124, which can limit the position of the transmission element 124 relative to the outer housing 1225, and facilitate a rapid installation of the transmission element 124 and the inner core 1226 to the outer housing 1225. A portion of the multiple limiting protrusions 12251 are provided at two ends of the movement path of the transmission element 124, so that a movement range of the transmission element 124 may be restricted, and within the above-mentioned limited movement range, the transmission element 124 is always in transmission connection with the movable assembly 112, and the transmission stability is guaranteed. In an embodiment of the present disclosure, in order to make the assembly more compact, the previously mentioned limiting strip 12261 may cooperate with one of the limiting protrusions 12251 to limit one end of the above-mentioned movement range, as shown in FIG. 61. The other portion of the multiple limiting protrusions 12251 are configured to restrict the transmission element 124 from moving in a direction away from the movement path, and together with the first guiding part 900 and the second guiding part 12262 mentioned above, may restrict the transmission element 124, to prevent the transmission element 124 from moving away from the first direction. In addition, in an embodiment of the present disclosure, the limiting protrusion 12251 may also abut the inner core 1226 against the main body assembly 111 to avoid axial movement of the inner core 1226.

In an exemplary embodiment, referring to FIGS. 42, 43, 45, 50, 55, 58, 61 and 64 together, the driving element 123 has a first driving part 1232, the connection plate 1245 has a second driving part 1243, one of the first driving part 1232 and the second driving part 1243 is a protrusion, and the other has a groove wall 12431 enclosing and forming a groove. The protrusion may be accommodated in the groove and is in transmission cooperation with the groove wall 12431. In this way, the groove wall 12431 may limit the protrusion to prevent the driving element 123 from being separated from the transmission element 124 during movement process, further improving the transmission stability between the driving element 123 and the transmission element 124. Meanwhile, the groove may avoid the protrusion, thereby avoiding interference on the motion of the first driving part 1232 and the second driving part 1243, and avoiding an occurrence of a jamming phenomenon.

A side of the first driving part 1232 that is in transmission cooperation with the groove wall 12431 is an arc-shaped surface 12321, so that there is a line-surface mating between the first driving part 1232 and the groove wall 12431, and a contact area between the first driving part 1232 and the groove wall 12431 may be reduced, thereby making the transmission smoother and further avoiding an occurrence of a jamming phenomenon. In an embodiment of the present disclosure, the first driving part 1232 is cylindrical.

In an exemplary embodiment, referring to FIGS. 43, 45, 56, 62 and 65 together, the transmission element 124 further includes a rack 1242, and at least one movement part 1244 is exposed to the inner core 1226 and is connected to the rack 1242. The operation mechanism 12 further includes a gear element 125 having a gear face, the gear element 125 is detachably connected to the movable assembly 112 and capable of an anti-rotation cooperation. The gear face engages with the rack 1242 to make the movable assembly 112 in transmission connection with the transmission element 124. In this way, the stable transmission of the driving force may be achieved by the cooperation between the rack 1242 and the gear face, and the driving force may be transmitted to the movable assembly 112 through the gear face, so as to drive the movable assembly 112 to rotate. The driving element 123 moves relative to the outer housing 1225 to drive the transmission element 124, so that the transmission element 124 may slide relative to the inner core 1226 through multiple movement parts 1244, and the rack 1242 may drive the gear face to roll relative to the rack 1242, so as to convert a linear motion of the transmission element 124 into a rotational motion of the gear face, thereby driving the rotational motion of the movable assembly 112, and a labor-saving and convenient liquid path switching is achieved.

In an exemplary embodiment, referring to FIGS. 41, 43, 45, 53, and 58 together, the inner core 1226 is provided with a penetrating slot 1000, and the gear element 125 is partially accommodated in the penetrating slot 1000 and rotatably connected to the inner core 1226, so that an arrangement of the penetrating slot 1000 may facilitate the rotation of the gear element 125 relative to the inner core 1226, thus improving the stability of the rotation of the gear element 125.

The connection plate 1245 shields at least a portion of a side of the penetrating slot 1000 facing the connection plate 1245, and cooperates with the main body assembly 111 to clamp the gear element 125 along an axial direction of the gear element 125, so as to limit the axial movement of the gear element 125 and ensure the transmission stability between the gear element 125 and the transmission element 124.

In an exemplary embodiment, referring to FIGS. 43, 45, 54 and 58 together, the liquid dispensing device 10 also includes a positioning component 13. The main body assembly 111 is provided with the positioning component 13 and the gear element 125 is provided with a positioning plate 1251. Multiple positioning grooves 1100 are provided on the positioning plate 1251, and the multiple positioning grooves 1100 are configured to cooperate with the positioning component 13 for positioning under different communication or discommunication states between the liquid intake channel 100 and the multiple liquid discharge channels 1400 respectively.

In an embodiment of the present disclosure, three positioning grooves 1100 corresponding to the first position, the second position and the third position are provided on the positioning plate 1251 to cooperate with the positioning component 13 when the movable assembly 112 rotates to the first position, the second position, and the third position, thus realizing a position feedback to prompt the rotation position of the movable assembly 112.

In an exemplary embodiment, continuously referring to FIGS. 43, 45, 54 and 58, the positioning component 13 includes an abutment structure 131 and an elastic structure 132. The main body assembly 111 is provided with a first installation space 12610, the abutment structure 131 is partially located in the first installation space 12610 and capable of slidably connecting with the positioning plate 1251. The elastic structure 132 is installed in the first installation space 12610 and capable of abutting the abutment structure 131 against the positioning plate 1251. In this way, a cooperation between the abutment structure 131 and the positioning plate 1251 may be tighter by an arrangement of the elastic structure 132, and a gap between the abutment structure 131 and the positioning plate 1251 may be avoided, which results in abnormal noise generated when the abutment structure 131 slides relative to the positioning plate 1251. In addition, the elastic structure 132 may further enable the abutment structure 131 to be relatively stable in the positioning groove 1100, so as to improve the accuracy of the position feedback. The elastic structure 132 may be, but is not limited to, a metal spring element and a plastic spring.

The elastic structure 132 is installed in the first installation space 12610, so that an extension and retraction of the elastic structure 132 has a certain directionality. The abutment structure 131 has a columnar structure and a spherical crown. The abutment structure 131 is partially located in the first installation space 12610, and may improve a movement accuracy under a restriction of the main body assembly 111. An arrangement of the spherical crown enables the abutment structure 131 to slide more smoothly relative to the positioning plate 1251, and avoids an occurrence of a jamming phenomenon.

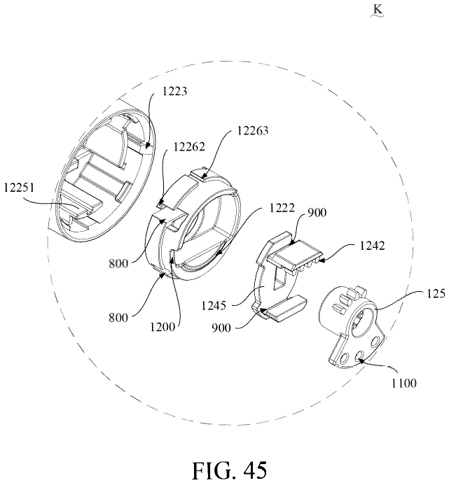

In an exemplary embodiment, referring to FIGS. 45 and 58 together, the inner core 1226 is further provided with an abutment part 1222, and the abutment part 1222 abuts against a side of the positioning plate 1251 facing away from the positioning component 13. In this way, an arrangement of the abutment part 1222 may provide support for the positioning plate 1251, improve the structural strength of the positioning plate 1251, and further improve the cooperation accuracy between the positioning plate 1251 and the positioning component 13. In an embodiment of the present disclosure, the abutment part 1222 is continuously or intermittently distributed along the rotation trajectory of the positioning plate 1251, and may always provide support for the positioning plate 1251 during the rotation process of the positioning plate 1251, so as to ensure the structural strength of the positioning plate 1251.

In an exemplary embodiment, as shown in FIG. 45, the inner core 1226 is provided with a limiting groove 1200. The abutment part 1222 is accommodated in the limiting groove 1200, and the positioning plate 1251 is at least partially accommodated in the limiting groove 1200, so that a limiting cooperation may be formed between the positioning plate 1251 and the inner core 1226 by an arrangement of the limiting groove 1200, a rotation range of the positioning plate 1251 may be restricted, and the positioning plate 1251 is always located in the movement path of the abutment structure 131.

In an exemplary embodiment, referring to FIGS. 40, 41, 44, 46, 52, 55, 57, 58, 61, and 64 together, the driving element 123 may be swung relative to the outer housing 1225, so as to drive the movable assembly 112 to rotate relative to the main body assembly 111 by the transmission element 124. In this way, the driving element 123 forms a structure that may be swung relative to the outer housing 1225, and may cooperate with the outer housing 1225 to form a labor-saving lever structure, so that the transmission element 124 is convenient to be driven, and the movable assembly 112 may rotate relative to the main body assembly 111. The above-mentioned lever structure may also compensate for a problem that a torque of a gear pair formed by the rack 1242 and the gear face cannot increase insufficient switching force under the limiting of the shape of the liquid dispensing device 10. The liquid path is switched by a swinging mode, and a swinging motion of the driving element 123 is converted into a linear motion of the transmission element 124, and then the linear motion of the transmission element 124 is converted into a rotational motion of the movable assembly 112, thereby realizing a labor-saving and convenient liquid path switching.

One of the outer housing 1225 and the driving element 123 is provided with a rotary shaft 1224, and the other of the outer housing 1225 and the driving element 123 may be rotatably connected to the rotary shaft 1224, so that the driving element 123 may be swung relative to the outer housing 1225. In this way, an arrangement of the rotary shaft 1224 may improve the stability of the swinging of the driving element 123 relative to the outer housing 1225, and a lever fulcrum structure formed at a position of the rotary shaft 1224 is more stable, thereby improving the stability of driving the transmission element 124. In an embodiment of the present disclosure, the rotary shaft 1224 is provided on the outer housing 1225, and the driving element 123 is rotatably connected to the rotary shaft 1224.

The other of the outer housing 1225 and the driving element 123 may be detachably connected to the rotary shaft 1224 to facilitate updating, upgrading, changing or replacement due to damage of the driving element 123. In an embodiment of the present disclosure, the driving element 123 is provided with a clamp opening part 1231 to facilitate clamping with and separating from the rotary shaft 1224.

In an exemplary embodiment, referring to FIGS. 41, 42, 44, 55, 58, 61 and 64 together, the liquid dispensing device 10 further includes a pin shaft 14. The other of the outer housing 1225 and the driving element 123 is further connected to the rotary shaft 1224 by the pin shaft 14. In this way, a connection stability between the outer housing 1225 and the driving element 123 may be further improved by an arrangement of the pin shaft 14, and a stable connection between the outer housing 1225 and the driving element 123 may be ensured while increasing the driving force of the driving element 123.

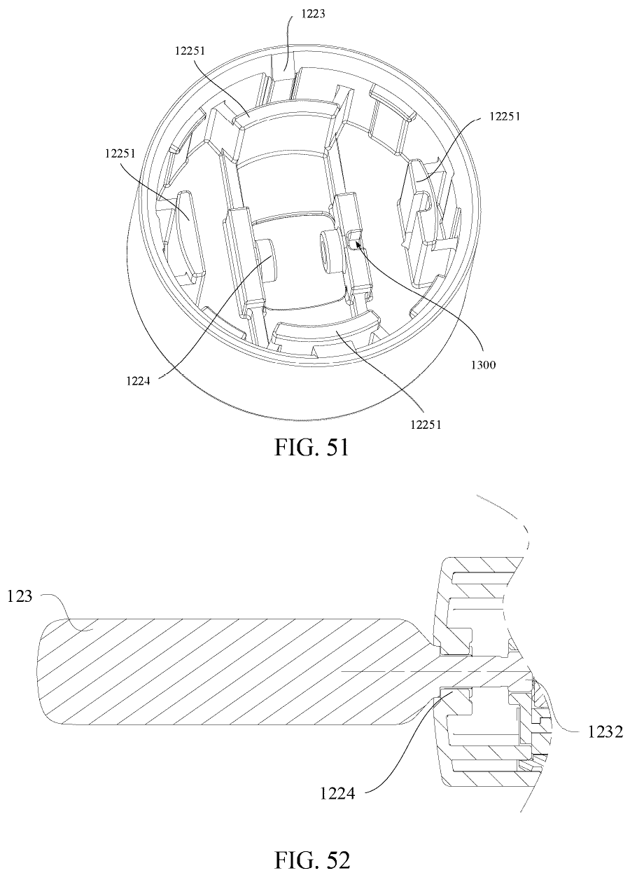

As shown in FIGS. 51 and 58, an avoidance space 1300 is provided on the connection element 122, and the avoidance space 1300 is provided with an installation space for the pin shaft 14, so as to facilitate the disassembly and assembly of the pin shaft 14, and to further facilitate updating, upgrading, changing or replacement due to damage of the driving element 123. In an embodiment of the present disclosure, the outer housing 1225 is provided with the avoidance space 1300.

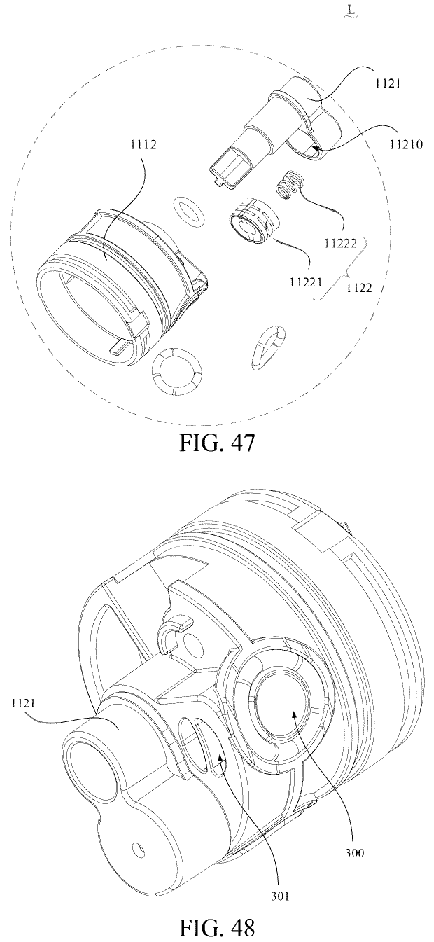

In an exemplary embodiment, referring to FIGS. 47 to 49, 54, 59, 60, 63 and 66 together, the movable assembly 112 includes a rotation element 1121 and a sealing element 1122. The rotation element 1121 is rotatably connected to the main body assembly 111, and the sealing element 1122 is provided on the rotation element 1121. The transmission element 124 may drive the rotation element 1121 to rotate relative to the main body assembly 111 so that the sealing element 1122 slides relative to the main body assembly 111. In this way, when the rotation element 1121 moves relative to the main body assembly 111, the sealing element 1122 may slide relative to the main body assembly 111 while maintaining the fit between the sealing element 1122 and the main body assembly 111. In an embodiment of the present disclosure, the sealing element 1122 is fitted to the liquid dispensing element 1112 and may slide relative to the liquid dispensing element 1112 when the rotation element 1121 rotates relative to the main body assembly 111. The rotation element 1121 is inserted into the liquid dispensing element 1112 and irrotationally connected to the gear element 125, and the other end is connected to the sealing element 1122, so that the sealing element 1122 is fitted to a side of the liquid dispensing element 1112 facing away from the gear element 125.

During a rotation process of the rotation element 1121 relative to the main body assembly 111, the sealing element 1122 is capable of sealing at least one of the multiple liquid discharge channels 1400 to discommunicate at least one of the multiple liquid discharge channels 1400 from the liquid intake channel 100, or exposing the multiple liquid discharge channels 1400 on the main body assembly 111 to communicate the multiple liquid discharge channels 1400 with the liquid intake channel 100.

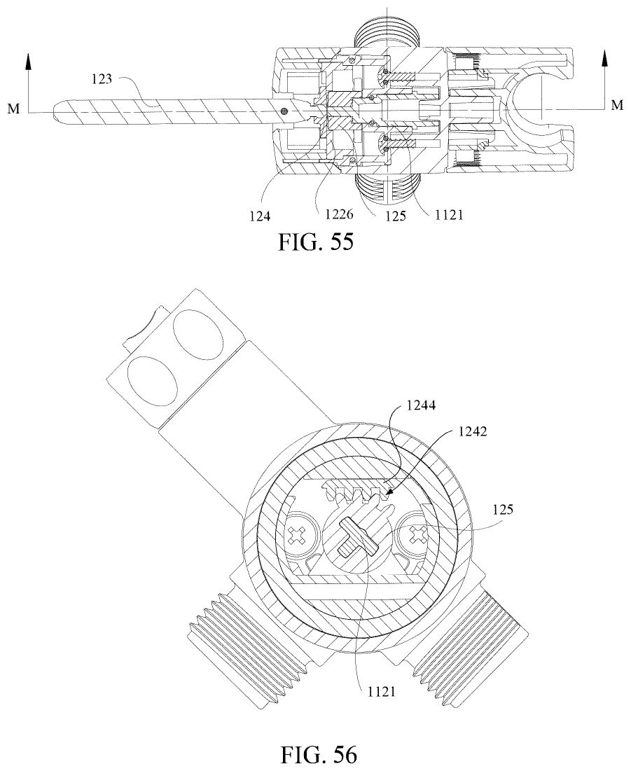

As shown in FIGS. 55 to 60, at a first position, the seal element 1122 seals a portion of the first liquid discharge hole 201 and a portion of the second liquid discharge hole 301 so that the liquid intake channel 100 may communicate with the first liquid discharge channel 200 and the second liquid discharge channel 300, respectively, and the first liquid discharge channel 200 and the second liquid discharge channel 300 may simultaneously discharge liquid.

As shown in FIGS. 61 to 63, at a second position, the sealing element 1122 seals the second liquid discharge hole 301 so that the liquid intake channel 100 communicates with the first liquid discharge channel 200, thereby enabling the first liquid discharge channel 200 to discharge liquid.

As shown in FIGS. 64 to 66, at a third position, the sealing element 1122 seals the first liquid discharge hole 201 so that the liquid intake channel 100 communicates with the second liquid discharge channel 300, thereby enabling the second liquid discharge channel 300 to discharge liquid.

In addition, in some exemplary embodiments, the sealing element 1122 may also seal the first liquid discharge hole 201 and the second liquid discharge hole 301 simultaneously, so that the liquid intake channel 100 may be discommunicated from both the first liquid discharge channel 200 and the second liquid discharge channel 300, and both the first liquid discharge channel 200 and the second liquid discharge channel 300 may simultaneously not discharge liquid.

It can be understood that in other embodiments, the rotation trajectory of the movable assembly 112 rotating relative to the main body assembly 111 may further include other positions for the switching of other liquid paths.

In an exemplary embodiment, referring to FIGS. 47, 49 and 59 together, the sealing element 1122 includes a flexible part 11221 and an elastic part 11222. The flexible part 11221 may be elastically abutted against the main body assembly 111 and the flexible part 11221 may be better fitted against the main body assembly 111 by deforming itself to ensure a tighter fit between the sealing element 1122 and the main body assembly 111.

The elastic part 11222 is supported between the rotation element 1121 and the flexible part 11221 to further enhance an elastic abutment force of the flexible part 11221 acting on the main body assembly 111, thereby further ensuring a tighter fit between the scaling element 1122 and the main body assembly 111, ensuring a reliability of a subsequent scaling of the first liquid discharge channel 200 or the second liquid discharge channel 300, and ensuring the stability of the liquid path switching. The flexible part 11221 may be made of, but is not limited to, an elastomer material. The elastic part 11222 may be, but is not limited to, a metal spring element and a plastic spring.

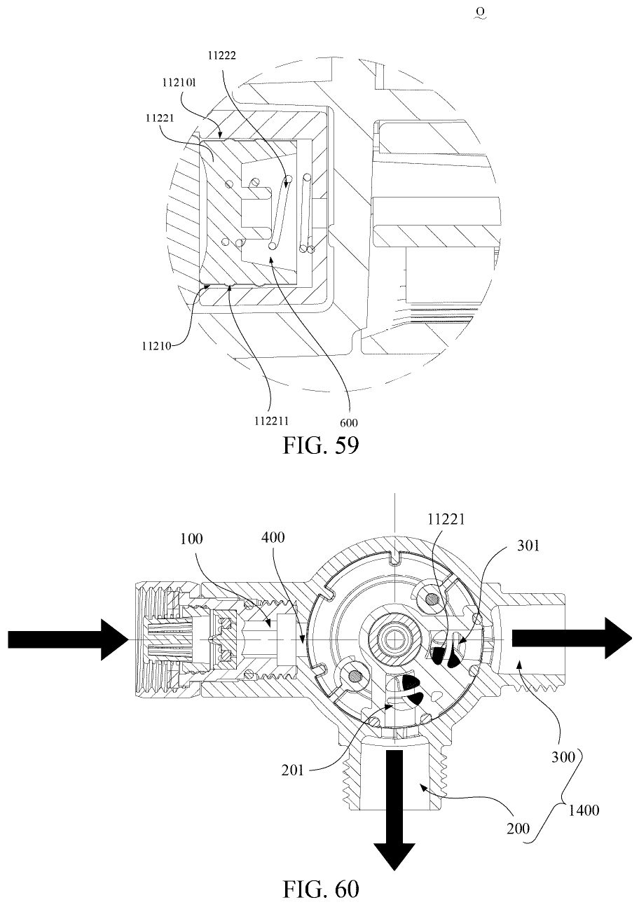

In an exemplary embodiment, referring to FIGS. 47 and 59 together, a second installation space 11210 is provided in the rotation element 1121, and the elastic part 11222 is installed in the second installation space 11210, so that the extension and retraction of the elastic part 11222 has a certain directionality.

The flexible part 11221 is partially accommodated in the second installation space 11210. In this way, a connection area between the flexible part 11221 and the rotation element 1121 may be increased, and a connection stability between the flexible part 11221 and the rotation element 1121 is increased.

In an exemplary embodiment, as shown in FIG. 59, an accommodation groove 600 is provided on a side of the flexible part 11221 facing away from the main body assembly 111, and the elastic part 11222 is partially accommodated in the accommodation groove 600, so as to improve the stability of the elastic deformation of the elastic part 11222. In an embodiment of the present disclosure, the accommodation groove 600 is a tapered hole.

The flexible part 11221 is provided with an arc-shaped protrusion 112211, and the arc-shaped protrusion 112211 abuts against the hole wall 112101 of the second installation space 11210. In this way, under an action of the flexible part 11221, the arc-shaped protrusion 112211 may be closely fitted against the hole wall 112101, and the flexible part 11221 may be more stably installed in the second installation space 11210.

In the description of the present disclosure, it should be noted that the orientation or position relationships indicated by the terms “upper”, “lower”, “one side”, “the other side”, “one end”, “the other end”, “side”, “relative”, “corners”, “periphery” and “square structure” or the like are based on the orientation or position relationships shown in the drawings, which are only for convenience of describing the present disclosure and simplifying the description, rather than indicating or implying that the structure referred has the specific orientation, or is constructed and operated in the specific orientation, and thus cannot be interpreted as a limitation on the present disclosure.

In the description of embodiments of the present disclosure, unless otherwise explicitly specified and limited, the terms “connection”, “direct connection”, “indirect connection”, “fixed connection”, “installation” and “assembly” should be broadly understood, for example, they may be fixed connection, detachable connection or integrated connection. The terms “installation”, “connection” and “fixed connection” may be direct connection, or indirect connection through an intermediate medium, or the internal communication between two elements. For those of ordinary skills in the art, the specific meanings of the aforementioned terms in the present disclosure may be understood according to specific situation.

Although the implementations of the present disclosure are disclosed above, the described contents are only the implementations adopted for facilitating understanding of the present disclosure, which are not intended to limit the present disclosure. It should be noted that the above embodiments or implementations are exemplary only and not limiting. Therefore, the present disclosure is not limited to what is specifically shown and described herein. Various modifications, substitutions or omissions may be made to the form and details of implementation without departing from the scope of the present disclosure.

From the foregoing, it will be appreciated that specific embodiments of the invention have been described herein for purposes of illustration, but that various modifications may be made without deviating from the scope of the invention. Accordingly, the invention is not limited except as by the appended claims.

1. A liquid dispensing device, comprising:
a liquid dispensing mechanism comprising a main body assembly and a movable assembly, wherein the main body assembly is provided with a liquid intake channel and a plurality of liquid discharge channels, and the movable assembly is movably installed to the main body assembly; and
an operation mechanism detachably connected with the liquid dispensing mechanism, wherein the operation mechanism is capable of driving the movable assembly to rotate relative to the main body assembly, so as to discommunicate at least one of the plurality of liquid discharge channels from the liquid intake channel, or to communicate the plurality of liquid discharge channels with the liquid intake channel.

2. The liquid dispensing device according to claim 1, wherein the operation mechanism comprises a rotary element, the rotary element is detachably connected with the movable assembly, the rotary element is capable of driving the movable assembly to rotate relative to the main body assembly, so as to discommunicate at least one of the plurality of liquid discharge channels from the liquid intake channel or to communicate the plurality of liquid discharge channels with the liquid intake channel.

3. The liquid dispensing device according to claim 2, wherein the rotary element is provided with a protrusion and the main body assembly is provided with a clamping groove;
the rotary element is capable of being clamped with the main body assembly by a cooperation between the protrusion and the clamping groove, and is capable of rotating relative to the main body assembly so as to drive the movable assembly to rotate relative to the main body assembly;
at least one of the rotary element and the main body assembly is further capable of being elastically deformed to move the protrusion out of the clamping groove; or
the operation mechanism further comprises a first positioning assembly;
the first positioning assembly is provided at the rotary element, and the main body assembly is provided with the first positioning element;
a plurality of first positioning parts are provided on the first positioning element, and the plurality of first positioning parts are configured to cooperate with the first positioning assembly for positioning under different communication or discommunication states between the liquid intake channel and the plurality of liquid discharge channels, respectively; or
a first plug part is provided on the rotary element, and the movable assembly is inserted into and engaged with and in anti-rotation cooperation with the first plug part;
the first plug part comprises a plurality of elastic arms, the plurality of elastic arms are provided on the rotary element and enclose and form a first plugging space, and the movable assembly is inserted into and engaged with the first plugging space; or
a driving protrusion is provided on the rotary element and configured to be capable of driving the rotary element to rotate relative to the main body assembly.

4. The liquid dispensing device according to claim 1, wherein the operation mechanism comprises a connection element, a driving element and a transmission element, the connection element is detachably connected to the main body assembly, both the driving element and the transmission element are movably connected to the connection element, and the driving element is movable relative to the connection element so as to drive the movable assembly to rotate relative to the main body assembly by the transmission element.

5. The liquid dispensing device according to claim 4, wherein a first sliding part extending in a first direction is provided on the connection element, and a second sliding part slidably mated with the first sliding part is provided on the transmission element, and the transmission element is capable of sliding with respect to the connection element through the cooperation between the first sliding part and the second sliding part; or
a first limiting part is provided on the connection element, a second limiting part that is in limiting cooperation with the first limiting part is provided on the main body assembly.

6. The liquid dispensing device according to claim 4, wherein the transmission element has a rack, and the operation mechanism further comprises a gear element having a gear face, the gear element is detachably connected to the movable assembly and capable of an anti-rotation cooperation;
the gear face engages with the rack to enable the movable assembly to be in transmission connection with the transmission element.

7. The liquid dispensing device according to claim 6, wherein the transmission element is slidably connected to the main body assembly, and the main body assembly abuts against a side of the transmission element facing away from the rack;
the operation mechanism further comprises a second positioning assembly;
the second positioning assembly is provided at the gear element, and the main body assembly is provided with a second positioning element;
a plurality of second positioning parts are provided on the second positioning element, and the plurality of second positioning parts are configured to cooperate with the second positioning assembly for positioning under different communication or discommunication states of the plurality of liquid discharge channels, respectively; and
the second positioning assembly comprises an installation component, an abutment component, and an elastic component; the installation component is provided with a first installation space, the abutment component is partially located in the first installation space and capable of slidably connecting with the second positioning element, and the elastic component is installed in the first installation space and capable of abutting the abutment component against the second positioning element.

8. The liquid dispensing device according to claim 7, wherein the connection element is further provided with an abutment part; and
the second positioning assembly is provided at the gear element, and the abutment part abuts against a side of the second positioning assembly facing away from the second positioning element.

9. The liquid dispensing device according to claim 4, wherein the connection element comprises an outer housing and an inner core that are detachably connected; the inner core is installed to the outer housing, the transmission element is movably installed between the outer housing and the inner core, and the outer housing is detachably connected to the main body assembly; the driving element is movably connected to the outer housing; and the driving element is movable relative to the outer housing, and drives the movable assembly to rotate relative to the main body assembly through the transmission element, so as to discommunicate at least one of the plurality of liquid discharge channels from the liquid intake channel, or to communicate the plurality of liquid discharge channels with the liquid intake channel.

10. The liquid dispensing device according to claim 9, wherein the transmission element comprises a plurality of movement parts, the inner core is provided with a plurality of sliding grooves extending in a first direction, the plurality of movement parts are accommodated in one-to-one correspondence in the plurality of sliding grooves and are capable of sliding relative to the inner core along the sliding grooves, and at least one of the movement parts is exposed to the inner core and is in transmission connection with the movable assembly; and
the sliding grooves are capable of penetrating at least one of two sides of the inner core that are opposite to each other in the first direction.

11. The liquid dispensing device according to claim 10, wherein a first guiding part is provided on a movement part; the inner core is provided with a second guiding part, and the second guiding part is located in a sliding groove; both the first guiding part and the second guiding part extend in the first direction, and one of the first guiding part and the second guiding part is capable of being accommodated in the other of the first guiding part and the second guiding part.

12. The liquid dispensing device according to claim 10, wherein the transmission element further comprises a connection plate, the plurality of movement parts are provided on the connection plate, the outer housing is provided with a plurality of limiting protrusions, and the plurality of limiting protrusions are provided on a circumferential outer side of the transmission element; and a portion of the plurality of limiting protrusions are provided at two ends of a movement path of the transmission element, the other portion of the plurality of limiting protrusions are configured to restrict the transmission element from moving in a direction away from the movement path.

13. The liquid dispensing device according to claim 12, wherein the transmission element further comprises a rack, and at least one of the movement parts is exposed to the inner core and is connected to the rack; the operation mechanism further comprises a gear element having a gear face, the gear element is detachably connected to the movable assembly and capable of an anti-rotation cooperation;
the gear face engages with the rack to enable the movable assembly to be in transmission connection with the transmission element;
the inner core is provided with a penetrating slot, and the gear element is partially accommodated in the penetrating slot and rotatably connected to the inner core; the connection plate shields at least a portion of a side of the penetrating slot facing the connection plate, and cooperates with the main body assembly to clamp the gear element along an axial direction of the gear element.

14. The liquid dispensing device according to claim 13, wherein the liquid dispensing device further comprises a positioning component;
the positioning component is provided on the main body assembly, and the gear element is provided with a positioning plate;
a plurality of positioning grooves are provided on the positioning plate, and the plurality of positioning grooves are configured to cooperate with the positioning component for positioning under different communication or discommunication states between the liquid intake channel and the plurality liquid discharge channels, respectively;
the positioning component comprises an abutment structure and an elastic structure, the main body assembly is provided with a first installation space, the abutment structure is partially located in the first installation space and capable of slidably connecting with the positioning plate, and the elastic structure is installed in the first installation space and capable of abutting the abutment structure against the positioning plate.

15. The liquid dispensing device according to claim 14, wherein the inner core is further provided with an abutment part, and the abutment part abuts against a side of the positioning plate facing away from the positioning component;
the inner core is provided with a limiting groove, the abutment part is accommodated in the limiting groove, and the positioning plate is at least partially accommodated in the limiting groove.

16. The liquid dispensing device according to claim 4, wherein the driving element is capable of being swung relative to the connection element to drive the movable assembly to rotate relative to the main body assembly by the transmission element;
the connection element is provided with a rotary shaft, and the driving element is rotatably connected to the rotary shaft, so that the driving element is capable of being swung relative to the connection element;
the driving element is capable of being detachably connected to the rotary shaft.

17. The liquid dispensing device according to claim 16, wherein the liquid dispensing device further comprises a pin shaft, and the driving element is further connected to the rotary shaft by the pin shaft;
an avoidance space is provided on the connection element, and the avoidance space is provided with an installation space for the pin shaft; or
the driving element has a first driving part, the transmission element has a second driving part, the first driving part is a protrusion, the second driving part has a groove wall that encloses and forms a groove, the protrusion is capable of being accommodated in the groove and is in transmission cooperation with the groove wall;
a side of the first driving part that is in transmission cooperation with the groove wall is an arc-shaped surface.

18. The liquid dispensing device according to claim 4, wherein the driving element is a shifter lever; or
the driving element is a rocker switch; or
the driving element is a push button, and the push button is capable of sliding relative to the connection element, so as to drive the movable assembly to rotate relative to the main body assembly through the transmission element.

19. The liquid dispensing device according to claim 1, wherein the movable assembly comprises a rotation element and a sealing element, the rotation element is rotatably connected to the main body assembly, and the sealing element is provided on the rotation element, the operation mechanism is capable of driving the rotation element to rotate relative to the main body assembly, so that the sealing element slides relative to the main body assembly;
during a rotation process of the rotation element relative to the main body assembly, the sealing element is capable of closing at least one of the plurality of liquid discharge channels, so as to discommunicate at least one of the plurality of liquid discharge channels from the liquid intake channel, or expose the plurality of liquid discharge channels on the main body assembly to communicate the plurality of liquid discharge channels with the liquid intake channel.

20. A liquid discharge system, comprising:
the liquid dispensing device according to claim 1; and
a plurality of liquid discharge elements, wherein the plurality of liquid discharge elements are communicated in one-to-one correspondence with the plurality of liquid discharge channels.
